(19) United States
(12) Patent Application Publication
(10) Pub. No.: US 2018/0251407 A1
(43) Pub. Date: Sep. 6, 2018

(54) PRECURSORS FOR CARBON-CARBON COMPOSITES

(71) Applicant: BLUE CUBE IP LLC, Clayton, MO (US)

(72) Inventors: Olivia E. Watkins, Clayton, MO (US); Hamed Lakrout, Clayton, MO (US); Maurice J. Marks, Clayton, MO (US); Lameck Banda, Clayton, MO (US)

(21) Appl. No.: 15/759,466

(22) PCT Filed: Sep. 27, 2016
(86) PCT No.: PCT/US16/53947

§ 371 Date: Mar. 12, 2018

Related U.S. Application Data
(60) Provisional application No. 62/234,862, filed on Sep. 30, 2015.

(51) Int. Cl. C04B 35/83; C08G 59/50; C08G 59/68; C08K 3/04; C08K 7/06; C08L 63/04; C04B 35/64; C04B 35/626

(52) U.S. Cl. CPC C04B 35/83; C08G 59/5093; C08G 59/687; C08K 3/04; C08K 7/06; C04B 2235/48; C04B 35/64; C04B 35/6269; C08L 2205/025; C04B 2235/5248; C08L 63/04

(57) ABSTRACT

The present invention provides a precursor curable composition including (a) at least one first epoxy resin; (b) at least one latent catalyst, (c) optionally, at least one curing agent, (d) optionally, at least one organic solvent, and (e) optionally, at least one second epoxy resin; wherein the thermal stability of the precursor curable composition when aged at 50 C for 16 days as measured by an increased 25 C viscosity from 0 percent to about 20 percent; and wherein, when the precursor curable composition is cured, the carbon yield of the cured precursor curable composition as measured by thermogravimetric analysis ranges from at least about 50 percent, based on the total weight of the cured composition without the optional organic solvent; a cured precursor composite material made from the above precursor curable composition; and a carbon-carbon composite product made from the above cured precursor composite material.

### FIELD OF THE INVENTION

The present disclosure generally relates to a precursor useful for making a carbon-carbon composite; a process for preparing the precursor; and to a process for preparing a carbon-carbon composite using the precursor.

### BACKGROUND OF THE INVENTION

Carbon-containing precursor compositions, such as compositions of a phenol-formaldehyde epoxy novolac resin in combination with one or more various curing agents, and the use of such carbon-containing precursor compositions for fabricating vitreous or non-graphitizing carbon are known in the art. However, the amount of curing agent typically used in the above known precursor compositions and required to produce a vitreous carbon in sufficient yield to be useful (e.g., a minimum yield of about 50 percent [%] or greater) using known processes exceeds the level required to formulate a thermally-stable, one-part resin composition. For example, the amount of curing agent used in combination with phenol-formaldehyde epoxy novolac resin is typically greater than 1 weight percent (wt %).

Also known in the art are processes for fabricating a carbon-carbon composite (“CCC”) by first contacting a plurality of carbon fibers with a phenolic resin composition to form a prepreg. The phenolic resin composition used to form the prepreg typically includes a significant amount (for example, approximately [˜] 50 wt % or greater) of organic solvent to adjust the viscosity (e.g., to less than 80.0 Pa-s at 25° C.) of the semi-solid or solid phenolic resin composition to enable the phenolic resin composition to wet the carbon fibers. However, addition of a solvent to the phenolic resin composition tends to decrease (e.g., to less than 10% of the original phenolic resin composition weight which includes the organic solvent) the amount of carbon in the resulting processed material. Alternatively, the phenolic resin composition can be heated at high temperatures (e.g., from about 120° C. to about 180° C.) in order to improve the processability of the phenolic resin composition, thus enabling the composition to wet the carbon fibers. However, this prematurely initiates the state of cure of the phenolic resin composition prior to impregnation.

Mackay (Sandia Labs Report (1969) SC-RR-68-651) discloses the evaluation of several thermosetting resins that provide useful carbon yields (e.g., greater than 50%); and discloses that certain resins that provide such high carbon yields have the following characteristics: (1) a high degree of aromaticity (e.g., greater than 2 aromatic benzene groups in a repeating unit), (2) a high molecular weight, (3) a capability to crosslink in the cure process, and (4) a capability to cyclize during carbonization. The above article discloses that carbonization of cured resin compositions such as phenolic resin compositions can achieve carbon yields of 9% to 65%. As a comparison, carbonization of phenol-formaldehyde epoxy novolac resins can achieve carbon yields from 23% to 55% as compared to 7% to 24% carbon yields for bisphenol A epoxy resins. The above article by Mackay also discloses that a higher molecular weight phenol-formaldehyde epoxy novolac resin, cured and carbonized with a curing agent such as boron trifluoride monoethyl amine, achieves carbon yields in the range from 49% to 54%. In contrast, a phenol-formaldehyde epoxy novolac resin, cured and carbonized with an aromatic amine curing agent such as m-phenylene diamine, achieves the least amount of carbon yield at a carbon yield of 29%. This comparison highlights the importance of the type of resin and curing agent for achieving the desired high carbon yield of greater than or equal to (≥) about 50%. The above article does not disclose catalyst concentrations and the relationship of catalysts to the thermal stability of the cured and carbonized compositions disclosed.

Chen et al (J. Appl. Polym. Sci., 37 (1989), 1105-1124) discloses when 3% to 4% boron trifluoride monoethyl amine is used as a curing agent with an epoxy resin, the mechanical and thermomechanical properties (e.g., glass transition temperature [Tg] and carbon yield) of the resulting cured epoxy resin are maximized such as a Tg of 168° C. and a carbon yield of 35%. However, the above article by Chen also discloses that the use of 2.8% to 8% of the boron trifluoride monoethyl amine curing agent with a bisphenol A epoxy resin produces carbon yields in the range from 17% to 26% after cure and carbonization. Conversely, it has been found that when a high molecular weight and high aromatic (e.g., 4 aromatic benzene groups in a repeating unit) 9,9-bis[4-hydroxy-phenyl]fluorene diglycidyl ether epoxy resin is cured and carbonized with boron trichloride monoethyl amine in the concentration range of from 2.8% to 8%, carbon yields in the range of from 25 to 34% are achieved. However, unsatisfactory results are still obtained as demonstrated by a cured epoxy resin having carbon yield below 50% is obtained.

Japanese Patent Publication No. 29432/74 discloses a method for producing a CCC which includes the steps of: (I) mixing (A) organic fibers, such as pitch fibers; and (B) an organic binder, such as a phenolic resin or furfural resin, having a carbonization yield of at least 10%; (II) pre-shaping the mixture to form a precursor article; and (III) firing the resultant precursor article to form the CCC product. However, the above described method suffers from several disadvantages including, for example, the composition includes a substantial amount of solvent (e.g., more than 50 wt %) to reduce the viscosity of the composition. This viscosity reduction is needed since the phenolic resin or furfural resins are typically a solid or semi-solid at 25° C. Using a solvent in an amount of more than half of the total weight of a final composition poses the disadvantage of increasing undesirable volatile organic compounds (VOC). In addition, the amount of carbon in the resulting cured precursor article, made from a composition with a substantial amount of solvent, is low (e.g., not more than 10% of the original composition weight which includes the organic solvent).

U.S. Pat. No. 3,462,289 discloses a method for manufacturing a CCC of a desired density by using the following steps: (i) dry stacking woven carbon fibers to form a preform; (ii) pressure impregnating the preform with a liquid phenol resin; (iii) compressing the preform to remove excess resin; (iv) curing the compressed and impregnated preform; (v) carbonizing the compressed/impregnated preform in an inert atmosphere; and then (vi) repeating the impregnation and carbonization steps to obtain the desired density of the resultant article.

US Invention US H420 H discloses a process for forming a CCC with improved interfacial bonding of a fibrous precursor and a resin matrix to insure “shrinkage matching” during processing of the fibrous precursor and resin matrix. The process disclosed in the above reference is carried out using the following steps: (i) heat treating a carbon fiber (e.g., phenolic or polyacrylonitrile[PAN] fibers) in an oxidizing atmosphere; (ii) impregnating the carbon fiber with an admixture of a resin (e.g., phenolic, furan, or polyphenylene resin) and a solvent (the impregnation is performed, for example, by immersion or vacuum infiltration); (iii) evaporating the solvent; (iv) layering the impregnated carbon fiber to form a prepreg; and (v) curing and carbonizing the prepreg to produce a CCC product.

In industry, there exists a need for producing carbon-carbon composites more efficiently, with reduced cost, and having a carbon yield of greater than 50%. In addition, the precursor curable compositions which ultimately form these CCC need to possess a high carbon yield, low use of solvents, high thermal stability over a period of time, and a low viscosity necessary for impregnation of a fiber.

### SUMMARY OF THE INVENTION

Disclosed herein are precursor curable compositions, cured precursor curable compositions or cured precursor composite materials, carbon-carbon composites, processes for preparing the precursor curable compositions, processes for preparing the cured precursor curable compositions, and processes for producing the carbon-carbon composite from the cured precursor curable composition.

In one aspect, a precursor curable composition or composition useful for preparing a carbon-carbon composite are disclosed. The precursor curable composition comprise (a) at least one first epoxy resin such as for example a bisphenol F-type epoxy resin or a phenol-formaldehyde epoxy novolac resin, or a mixture thereof, (b) at least one latent catalyst, (c) optionally, at least one curing agent, (d) optionally, at least one organic solvent, and (e) optionally, at least one second epoxy resin, wherein the at least one second epoxy resin is not the same as the first epoxy resin. These precursor curable compositions afford a CCC having a carbon yield of at least 50%, increased thermal stability, and low viscosity.

In another aspect, disclosed herein are cured precursor curable compositions or cured precursor composite materials by curing the precursor curable composition.

In a further aspect, disclosed are carbon-carbon composite materials produced by pyrolyzing or carbonizing the cured precursor composite material.

In an additional aspect, processes for preparing the precursor curable composition comprising mixing or dispersing a) at least one first epoxy resin such as for example a bisphenol F-type epoxy resin or a phenol-formaldehyde epoxy novolac resin, or a mixture thereof, (b) at least one latent catalyst, (c) optionally, at least one curing agent, (d) optionally, at least one organic solvent, and (e) optionally, at least one second epoxy resin. Other additional components known to the skilled artisan may be added to the composition.

In still another aspect, disclosed herein are processes for curing the precursor curable composition.

Yet another embodiment is directed to a process for producing the carbon-carbon composite from the cured precursor composite material.

In accordance with the present invention, a precursor curable composition is first prepared. The precursor curable composition is then cured forming a cured precursor composite material. This cured precursor composite material is used for preparing a carbon-carbon composite product. In one preferred embodiment, the carbon-carbon composite product is produced by impregnated a carbon fiber material with the precursor curable composition and then curing the impregnated carbon fiber material to form a cured precursor composite material, which is then carbonized to form a carbon-carbon composite product, wherein the carbon yield of the pyrolyzed, cured precursor composite material is at least 50 wt %, based on the initial weight of the cured composition prior to pyrolysis of the composition cured and impregnated carbon fiber material (excluding the amount of carbon fiber material).

The present invention realizes the benefit of using a high carbon yielding composition of at least one first epoxy resin such as a bisphenol F-type epoxy resin, phenol-formaldehyde novolac epoxy resin, or a mixture thereof with at least one latent catalyst and, optionally, at least one curing agent having superior thermal stability with optional addition of from about 0 wt % to about 40 wt % organic solvent to achieve a viscosity range from 0.1 Pa-s to about 100.0 Pa-s measured at 25° C. and 0.1 Pa-s to about 250.0 Pa-s measured at 50° C. for the resin composition. This viscosity is sufficient for the impregnation/wetting of carbon fibers or the development of a prepreg which can be used for manufacturing a carbon-carbon composite.

Other features and iterations of the invention are described in more detail below.

### DETAILED DESCRIPTION OF THE INVENTION

As previously mentioned, disclosed herein are precursor curable composition useful for preparing a carbon-carbon composite comprising (a) at least one first epoxy resin such as for example a bisphenol F-type epoxy resin or a phenol-formaldehyde epoxy novolac resin, or a mixture thereof, (b) at least one latent catalyst, (c) optionally, at least one curing agent, (d) optionally, at least one organic solvent, and (e) optionally, at least one second epoxy resin. These precursor curable compositions exhibit high thermal stability, low viscosity, and a high carbon yield of at least 50%. The precursor curable compositions are cured to form the cured precursor composite material. These cured precursor composite materials are useful in preparing carbon-carbon composites with a high carbon yield of at least 50%.

### (I) Precursor Curable Composition

In one aspect, the precursor curable composition comprises (a) at least one epoxy resin and (b) at least one latent catalyst. Optionally, the precursor composition may also comprise (c) at least one curing agent; (d) at least one organic solvent, and (e) a second epoxy resin. Additional compounds may be added to the composition as known by the skilled artisan.

### (a) AT LEAST ONE FIRST EPOXY RESIN

The at least one first epoxy resin compound, component (a), may be a single epoxy resin compound used alone or a mixture of two or more epoxy compounds used in combination. The first epoxy resin compound may include a bisphenol F-type epoxy resin. The aromatic groups of the bisphenol F-type epoxy resin structure may be independently substituted with aliphatic, cycloaliphatic, cyclic, heterocyclic aromatic, polyaromatic, and unsaturated hydrocarbon groups.

For example, a “bisphenol F-type epoxy resin” refers to epoxy resins having the base bisphenol F structure of 1,1′-methylenebis[benzene] as illustrated in the following structure:

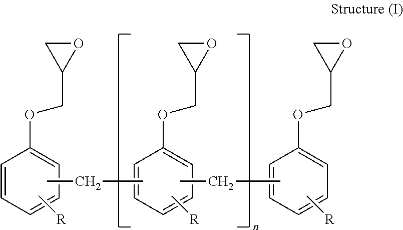

where in Structure (I) above, n is ≥ to 0; and each R, independently, may be one or more substituted with aliphatic, cycloaliphatic, cyclic, heterocyclic, aromatic, polyaromatic, or, unsaturated hydrocarbon groups. The hydrocarbons may be from C1 to C30 The bisphenol F-type epoxy resin may include for example phenol-formaldehyde novolac epoxy resin (epoxidized phenol-formaldehyde novolac), bisphenol F epoxy resin (diglycidyl ether of bisphenol F), or mixtures thereof.

Suitable commercially available of the at least first epoxy resin compounds may be epoxy resins commercially available from The Dow Chemical Company. Non-limiting examples of these commercially available epoxy resins from The Dow Chemical Company may be such the D.E.R.™ 300 series such as DER 354, the D.E.N.™ 400 series, and mixtures thereof. The D.E.N.™ 400 series epoxy resins are epoxy novolac resins. Some non-limiting examples of preferred embodiments of commercial epoxy resin compounds may be bisphenol F type epoxy resins such as D.E.R. 354 (The Dow Chemical Company); bisphenol F epoxy novolac resins such as D.E.N. 438 or D.E.N. 439 (The Dow Chemical Company); bisphenol F epoxy novolac resins with solvent (The Dow Chemical Company) including for example D.E.N. 438-A85 which is a solution of D.E.N 438 in 15% acetone, D.E.N. 438-EK85 which is a solution of D.E.N 438 in 15% methyl ethyl ketone, D.E.N. 438-MAK80 which is a solution of D.E.N 438 in 20% methyl n-amyl ketone, D.E.N. 438-MK75 which is a solution of D.E.N 438 in 25% methyl isobutyl ketone, D.E.N. 438-X80 which is a solution of D.E.N 438 in 20% xylene, and D.E.N. 439-EK85 which is a solution of D.E.N 439 in 15% methyl ethyl ketone; and mixtures thereof.

Other suitable epoxy resins useful as the first bisphenol F-type epoxy resin, component (a), are disclosed in U.S. Pat. Nos. 3,018,262; 7,163,973; 6,887,574; 6,632,893; 6,242,083; 7,037,958; 6,572,971; 6,153,719; 8,048,819, 7,655,174, 5,405,688; and PCT Publication WO 2006/052727; each of which is hereby incorporated herein by reference. Examples of the first bisphenol F-type epoxy resins suitable for use in the compositions are also described, for example, in U.S. Pat. Nos. 5,137,990 and 6,451,898, which are incorporated herein by reference.

The first epoxy resin compound, component (a), may also include for example naphthalene diglycidyl ethers. Each of the aromatic rings of the naphthalene diglycidyl ether structure may be independently substituted with be one or more of aliphatic, cycloaliphatic, cyclic, heterocyclic, aromatic, polyaromatic, or, unsaturated hydrocarbon groups.

### (b) AT LEAST ONE LATENT CATALYST COMPOUND

The at least one latent catalyst compound, component (b) may be a single latent catalyst compound or a combination of two or more latent catalyst compounds. The latent catalyst functions as curing catalyst. A “latent catalyst”, “curing catalyst” or “cure catalyst” refers to a compound used to facilitate the curing reaction of the at least one epoxy resin. The latent catalyst may be selected based on the epoxy resin employed in the precursor curable composition; and/or any of the optional components employed in the precursor curable composition such as an optional curing catalyst or solvent. Non-limiting examples of latent catalyst may be imidazoles, tertiary amines, phosphonium complexes, Lewis acids, Lewis bases, transition metal catalysts, and mixtures thereof. The latent catalyst may include Lewis acids such as boron trifluoride complexes; Lewis bases such as tertiary amines like diazabicycloundecene and 2-phenylimidazole; quaternary salts such as tetrabutylphosphonium bromide and tetraethylammonium bromide; and organoantimony halides such as triphenylantimony tetraiodide and triphenylantimony dibromide; and mixtures thereof. In a preferred embodiment, the latent catalyst may be methyl-para-toluene sulfonate (MPTS); ethyl-para-toluene sulfonate (EPTS); methyl methanesulfonate (MMS), and mixtures thereof.

In one illustrative embodiment, the latent catalyst may be at least one acid compound-related cure catalyst to promote the cure reaction of the epoxy compound. For example, the latent catalyst may include any one or more of the catalysts described in U.S. patent application Ser. No. 14/348,207, such as for example Bronsted acids (e.g., CYCAT® 600 commercially available from Cytec), Lewis acids, and mixtures thereof. In another embodiment, the catalysts may a latent alkylating ester such as for example any one or more of the catalysts described in WO 9518168, incorporated herein by reference.

In another embodiment, the latent alkylating ester cure catalyst may be an ester of a sulfonic acid. Non-limiting embodiments of the esters of sulfonic acids may be alkylating esters of para-toluene and methane sulfonic acids such as methyl p-toluenesulfonate (MPTS), ethyl p-toluenesulfonate (EPTS), and methyl methanesulfonate (MMS); alkylating esters of α-halogenated carboxylic acids such as methyl trichloroacetate (MTCA) and methyl triflouroacetate (MTFA); and alkylating esters of phosphoric acids such as tetraethylenediphosphate; or any combination thereof. One preferred embodiment of the cure catalyst used may include for example MPTS. Other curing catalysts may include those described in co-pending U.S. Provisional Patent Application No. 61/660,397, incorporated herein by reference.

Generally, the amount of the latent catalyst may range from 1 wt % to about 15 wt %. In various embodiments, the amount of the latent catalyst may range from 1 wt % to 15 wt %, from 1 wt % to about 14 wt %, from 2 wt % to 13 wt %, from 3 wt % to 12 wt %, or from 4 wt % to 10 wt %. The use of lower levels of the latent catalyst of less than about 1 wt % would reduce reactivity and would result in less crosslinked network; and the use of higher levels of latent catalyst of more than about 15 wt % would tend to be uneconomical.

### (c) OPTIONAL AT LEAST ONE CURING AGENT, COMPONENT (c)

At least one curing agent, optional component (c) may be added to the composition. In general, a curing agent (also referred to as a hardener or a crosslinking agent), is blended with the epoxy resin, component (a), and the latent catalyst, component (b), to prepare the curable composition. Then, the curable composition can then be cured under curing conditions to form a cured product or thermoset which is in the form of a solid carbon cured composite. The optional curing agent may be Bronsted acids, Lewis acids, Lewis bases, alkali bases, Lewis acid-Lewis base complexes, quaternary ammonium compounds, quaternary phosphonium compounds, or mixtures thereof. Non-limiting examples of the optional curing agent may be sulfuric acid, sulfonic acids, perchloric acid, phosphoric acid, partial esters of phosphoric acid, boron trifluoride, tertiary amines, imidazoles, amidines, substituted ureas, sodium hydroxide, potassium hydroxide, boron trifluoride-ethylamine complex, benzyltrimethylammonium hydroxide, tetrabutylphosphonium hydroxide, and mixtures thereof.

The optional curing agent is described in co-pending U.S. patent application Ser. No. 14/391,732, which is incorporated herein by reference.

In various embodiments, the optional curing agent compound may be a tertiary amine such as dimethylbenzylamine (BDMA), tris(dimethylaminomethyl)phenol (DMP-30) and 1,4-diazabicyclo-[2.2.2]octane (DABCO); a Lewis acid complex such as boron trichloride-N,N-dimethyloctylamine adduct (Araldite DY 9577, BCI3-DMOA) and boron trifluoride monoethyl amine (BF₃-MEA); an imidazole such as 4-methyl-2-phenylimidazole (2P4MZ) and 1-azine-2-methylimidazole (2MZA-PW); and mixtures thereof.

Generally, the amount optional curing agent may range from 0 wt % to about 3 wt %. In various embodiments, the amount of the optional curing agent may range from 0 wt % to 3 wt %, from 0.01 wt % to about 2.5 wt %; from 0.02 wt % to about 2 wt %, or from 0.05 wt % to about 1.5 wt %.

### (d) OPTIONAL SOLVENT, COMPONENT (d)

A solvent, optional component (d) may be added to the composition. The optional solvent may be used in the precursor curable composition to lower the viscosity of the composition from its initial viscosity, if desired. For example, the optional solvent component may include any solvent or diluent which is essentially inert to the components during the precursor curable composition and which provides the necessary solubility to lower the initial viscosity of the precursor curable composition.

Generally, optional solvents or diluents may include alcohols, esters, glycol ethers, ketones, aliphatic and aromatic hydrocarbons, combinations thereof and the like. Non-limiting examples of optional solvents may be isopropanol, n-butanol, tertiary butanol, acetone, methyl ethyl ketone, methyl isobutyl ketone, methyl n-amyl ketone, butylene glycol methyl ether, ethylene glycol methyl ether, ethylene glycol ethyl ether, ethylene glycol n-butyl ether, ethylene glycol phenyl ether, diethylene glycol n-butyl ether, diethylene glycol ethyl ether, diethylene glycol methyl ether, propylene glycol methyl ether, propylene glycol ethyl ether, propylene glycol n-butyl ether, propylene glycol phenyl ether, dipropylene glycol methyl ether, dipropylene glycol n-butyl ether, tripropylene glycol methyl ether, xylenes, and mixtures thereof.

Generally, the amount of optional solvent or diluent may range 0 wt % to about 40 wt %. In various embodiments, the amount of optional solvent or diluent may range from 0 wt % to 40 wt %, from 0.001 wt % to 37 wt %, from 0.01 wt % to about 35 wt %, from 1 wt % to about 25 wt %, from 5 wt % to about 20 wt %, or from 10 wt % to 15 wt %.

### (E) OPTIONAL AT LEAST ONE SECOND EPOXY RESIN

The precursor curable composition may also optionally include at least one second epoxy resin, optional component (e). The optional second epoxy resin is a separate and independent component of the curable composition wherein the second epoxy resin is not the same as the first epoxy resin. As an example, when the first epoxy resin includes a bisphenol F-type epoxy resin, the second epoxy resin is different from the bisphenol F-type epoxy resin and may include other epoxy resins well known in the art. The optional second epoxy resin useful in the present invention curable composition may be monomeric, oligiomeric, or polymeric compounds containing at least one vicinal epoxy group. Additionally, the second epoxy resin may be aliphatic, cycloaliphatic, aromatic, cyclic, heterocyclic or mixtures thereof. The second epoxy resin may be saturated or unsaturated. The second epoxy resin may be substituted or unsubstituted. An extensive enumeration of the second epoxy resin useful in the present invention is found in Lee, H. and Neville, K., “Handbook of Epoxy Resins,” McGraw-Hill Book Company, New York, 1967, Chapter 2, pages 257-307; incorporated herein by reference.

The second epoxy resin may vary depending on the application in which the precursor curable composition will be used; and may include conventional and commercially available epoxy resins. The second epoxy resin, also referred to as a polyepoxide, may be a product that has, on average, more than one unreacted epoxide unit per molecule. In choosing the second epoxy resin consideration should be given to the viscosity of the precursor curable composition and other properties of the precursor curable composition that may influence the processing of the precursor curable composition; and to the desired properties of the final composite product made from the precursor curable composition.

Suitable conventional second epoxy resin compounds utilized in the precursor curable composition may be prepared by processes known in the art, such as for example, a reaction product based on the reaction of an epihalohydrin and (1) a phenol or a phenol type compound, (2) an amine, or (3) a carboxylic acid. Suitable conventional second epoxy resins used may also be prepared from the oxidation of unsaturated compounds. Non-limiting examples of the second epoxy resin may be a reaction product of epichlorohydrin with polyfunctional alcohols, phenols, bisphenols, halogenated bisphenols, hydrogenated bisphenols, novolac resins, o-cresol novolacs, phenol novolacs, polyglycols, polyalkylene glycols, cycloaliphatics, carboxylic acids, aromatic amines, aminophenols, or combinations thereof. The preparation of the optional second epoxy compound is described for example in Kirk-Othmer, Encyclopedia of Chemical Technology, 3rd Ed., Vol. 9, pp 267-289.

Generally, suitable phenol, phenol-type or polyhydric phenol compounds useful for reacting with an epihalohydrin to prepare an epoxy resin may be a polyhydric phenol compounds having an average of more than one aromatic hydroxyl group per molecule. Non-limiting examples of these polyhydric phenol compounds may be dihydroxy phenols or biphenols; such as bisphenol A, bisphenol AP (1,1-bis(4-hydroxyphenyl)-1-phenyl ethane), bisphenol F, or bisphenol K; halogenated biphenols such as tetramethyl-tetrabromobiphenol or tetramethyltribromobiphenol; halogenated bisphenols such as tetrabromobisphenol A or tetrachlorobisphenol A; alkylated biphenols such as tetramethylbiphenol; alkylated bisphenols; trisphenols; phenol-aldehyde novolac resins (i.e., the reaction product of phenols and simple aldehydes, preferably formaldehyde) such as phenol-formaldehyde novolac resins, alkyl substituted phenol-formaldehyde resins, phenol-hydroxybenzaldehyde resins, alkylated phenol-hydroxybenzaldehyde resins, or cresol-hydroxybenzaldehyde resins; halogenated phenol-aldehyde novolac resins; substituted phenol-aldehyde novolac resins; phenol-hydrocarbon resins; substituted phenol-hydrocarbon resins; hydrocarbon-phenol resins; hydrocarbon-halogenated phenol resins; hydrocarbon-alkylated phenol resins; resorcinol; catechol; hydroquinone; dicyclopentadiene-phenol resins; dicyclopentadiene-substituted phenol resins; or combinations thereof.

In another embodiment, the at least one second epoxy resin may be the reaction product of amines with an epihalohydrin. Non-limiting examples of these amines may be diaminodiphenylmethane, aminophenol, xylene diamine, anilines, or combinations thereof.

In still another embodiment, the at least one second epoxy resin may be the reaction product of a carboxylic acids with an epihalohydrin. Non-limiting examples of useful carboxylic acids may be phthalic acid, isophthalic acid, terephthalic acid, tetrahydro- and/or hexahydrophthalic acid, endomethylenetetrahydrophthalic acid, isophthalic acid, methylhexahydrophthalic acid, or combinations thereof.

A few non-limiting embodiments of the optional second epoxy resin may be aliphatic epoxides prepared from the reaction of epihalohydrins and polyglycols. Non-limiting examples of these aliphatic epoxides may be trimethylpropane epoxide; diglycidyl-1,2-cyclohexane dicarboxylate, or mixtures thereof; diglycidyl ether of bisphenol A; resorcinol diglycidyl ether; triglycidyl ethers of para-aminophenols; halogen (for example, chlorine or bromine)-containing epoxy resins such as diglycidyl ether of tetrabromobisphenol A; epoxidized bisphenol A-formaldehyde novolac; an oxazolidone-modified epoxy resin; an epoxy-terminated polyoxazolidone; and mixtures thereof.

In other embodiments, the at least one second epoxy resin may be a commercial epoxy resin. Suitable commercially available second epoxy resin compounds may be epoxy resins commercially available from The Dow Chemical Company. Non-limiting examples of these commercial epoxy resin may be the D.E.R.™ 300 series, the D.E.R.™ 500 series, the D.E.R.™ 600 series and the D.E.R.™ 700 series of epoxy resins. Examples of bisphenol A based epoxy resins may include commercially available epoxy resins such as some of the D.E.R.™ 300 series and D.E.R.™ 600 series, commercially available from The Dow Chemical Company.

A few optional, non-limiting examples of preferred D.E.R.™ 300 series epoxy resin compounds useful as the second epoxy resin may be bisphenol-A-based epoxy resins such as diglycidyl ether of bisphenol A or other bisphenol-F-based epoxy resins such as other diglycidyl ethers of bisphenol F which are different from the first bisphenol F-type epoxy resin. For example, the second epoxy resin compound may include a liquid epoxy resin, such as D.E.R. 383 a diglycidylether of bisphenol A (DGEBPA) having an epoxide equivalent weight of from about 175 to about 185, a viscosity of about 9.5 Pa-s and a density of about 1.16 g/cc. Other commercial second epoxy resins that can be used for the epoxy resin component may be D.E.R. 330 and D.E.R. 332.

In general, the total concentration of the neat bisphenol F-type epoxy resin or mixture thereof may range from about 50 wt % to about 99 wt %. In various embodiments, the total concentration of the neat bisphenol F-type epoxy resin or mixture thereof may range from about 50 wt % to about 99 wt %, from 60 wt % to about 98 wt % from 70 wt % to about 97 wt %, and from 73 wt % to about 95 wt % based on the total weight of the components in the precursor curable composition.

### (F) OTHER OPTIONAL COMPONENTS

Other optional components that may be added to the precursor curable composition may include compounds that are normally used in curable resin compositions known to those skilled in the art. For example, the optional components may include compounds that can be added to the composition to enhance application properties (e.g., surface tension modifiers or flow aids), reliability properties (e.g., adhesion promoters) the reaction rate, the selectivity of the reaction, and/or the catalyst lifetime. Non-limiting examples of these optional compounds may be fillers; pigments; toughening agents; flexibilizing agents, processing aides; flow modifiers; adhesion promoters; diluents; stabilizers; plasticizers; catalyst de-activators; flame retardants; aromatic hydrocarbon resins, coal tar pitch; petroleum pitch; carbon nanotubes; graphene; carbon black; carbon fibers, or mixtures thereof.

Generally, the amount of these other optional compounds, may range from 0 wt % to about 80 wt %. In various embodiments, the amount of these other optional compounds, may range from 0 wt % to about 80 wt %, from 0.01 wt % to about 60 wt %, from 10 wt % to about 50 wt %, and from 20 wt % to about 40 wt %.

### (g) ILLUSTRATIVE EXAMPLES

In one illustrative embodiment which demonstrate good utility, the epoxy resin-based precursor curable composition can be used without a solvent; and in such case, the permissible component ranges for the precursor curable composition may be as follows: from 88 wt % to about 94 wt % of a bisphenol F-type resin or mixture thereof; from 0 wt % to about 1.5 wt % of a curing agent; and from 4 wt % to about 12 wt % of a latent catalyst.

In another illustrative embodiment for the preparation of the precursor starting from a bisphenol F epoxy resin, the permissible component ranges for the precursor curable composition can be as follows: from 88 wt % to about 96 wt % of an bisphenol F epoxy resin or mixture of bisphenol F epoxy resin and phenol-formaldehyde epoxy novolac resin; and from 4 wt % to about 12 wt % of a latent catalyst.

In still another illustrative embodiment, the permissible component ranges for the precursor curable composition may be as follows: from 74 wt % to about 88 wt % of an phenol-formaldehyde epoxy novolac resin; from 0.8 wt % to about 1.0 wt % of a curing agent; from 4.8 wt % to about 5.7 wt % of a latent catalyst; and from 5 wt % to about 20 wt % of an organic solvent.

In yet another illustrative embodiment of the present invention for the preparation of a carbon-carbon composite starting from a viscosity epoxy resin-based precursor curable composition, the permissible component ranges for the precursor curable composition can be as follows: from 74 wt % to about 88 wt % of an bisphenol F epoxy novolac resin; from 3.5 wt % to about 10 wt % of a latent catalyst; and from 5 wt % to about 20 wt % of an organic solvent.

In even still another illustrative embodiment, the permissible component ranges for the precursor curable composition may be as follows: from 0 wt % to about 30 wt % of an bisphenol F epoxy novolac resin; from 60 wt % to about 96 wt % of a bisphenol F epoxy resin; from 1 wt % to about 2 wt % of a curing agent; and from 3 wt % to about 10 wt % of a latent catalyst.

In even yet another illustrative embodiment, the permissible component ranges for the precursor curable composition can be as follows: from 0 wt % to 30 wt % of an phenol-formaldehyde epoxy novolac resin; from 60 wt % to about 94 wt % of a bisphenol F epoxy resin; and from about 4 wt % to about 12 wt % of a latent catalyst.

### (h) PROPERTIES OF THE PRECURSOR CURABLE COMPOSITION

The thermal stability and carbon yield of the precursor curable compositions are predicated on a delicate balance of the type and concentration of the epoxy resin, latent catalyst, and curing agent. The precursor curable composition, exhibiting the desired thermal stability (e.g., in which the viscosity build does not exceed 20% when aged for 16 days at 50° C.), and the desired carbon yield (e.g., which is at least greater than 50%), can be achieved with the above-described latent catalyst. However, by using the optional curing agent, as described above, the amount of latent catalyst used in the precursor curable composition can be reduced while advantageously maintaining an increase in the carbon yield. Because there are slight differences between the various first epoxy resin used in the precursor curable compositions, the carbon yield of the composition may be “fine-tuned” to achieve the desired carbon yield for a particular application. The “fine tuning” may be carried out by utilizing different types of first epoxy resin, latent catalyst and optional compounds; and/or by using different amounts of the components. For example, while the preferred carbon yield of a precursor curable composition may be achieved using a bisphenol F epoxy resin, the carbon yield of the precursor curable composition may be increased by using a phenol-formaldehyde epoxy novolac resin due to its greater number of repeating aromatic units compared to those of the bisphenol F epoxy resin.

One important property of the precursor curable composition is that the composition be in liquid form for processing the composition to cured solid state. In one embodiment, the curable precursor composition containing, for example, bisphenol F epoxy resin as the first epoxy resin; or a mixture of bisphenol F epoxy resin and phenol-formaldehyde epoxy novolac resin as the first epoxy resin; exhibits a low enough viscosity sufficient to allow the curable precursor composition to be processable and handleable in conventional composition equipment. For example, the epoxy-based curable precursor composition prepared by the above process advantageously exhibits a low enough viscosity of less than or equal to (≤) about 12.0 Pa-s at 25° C.

Generally, the viscosity of precursor curable composition using bisphenol F epoxy resin as the first epoxy resin; or a mixture of bisphenol F epoxy resin and phenol-formaldehyde epoxy novolac resin as the first epoxy resin may range from 0.1 Pa-s to about 50 Pa-s. In various embodiments, the viscosity of precursor curable composition may range from 0.1 Pa-s to about 50 Pa-s, from 1.0 Pa-s to about 20 Pa-s and from 1.5 Pa-s to about 12.0 Pa-s at 25° C. Because the precursor curable composition has a low enough viscosity, the precursor curable composition can be used without adding solvents or diluents to the precursor curable composition. Solvents or diluents are needed for the sole purpose of reducing the viscosity of the precursor curable composition and increasing the processability of the precursor curable composition. In other words, the precursor curable composition can be easily processed and readily handled in end-use processes for forming thermoset products. However, a solvent may be used and therefore the solvent compound is optional as described above.

Precursor curable compositions using the phenol-formaldehyde novolac epoxy resin exhibit viscosities in the range of from about 25.0 Pa-s to about 250.0 Pa-s at 50° C. The precursor curable composition exhibits a viscosity low enough to reduce the need for high temperatures to lower the composition viscosity and enable wetting of the carbon fiber and concurrently limiting the premature initiation of cure. However, addition of small amounts of organic solvent aid processability of the precursor curable composition and improve the ability to wet the carbon fibers without significant amounts of solvent [e.g., less than about 50%]. For example, the curable precursor composition advantageously exhibits a viscosity of less than or equal to (≤) about 80.0 Pa-s at 25° C. or less than or equal to (≤) about at 4.0 Pa-s at 50° C.

Generally, the viscosity of precursor curable composition using the phenol-formaldehyde novolac epoxy resin may range from 0.1 Pa-s to about 100 Pa-s at 25° C. In various embodiments, the viscosity of precursor curable composition using the phenol-formaldehyde novolac epoxy resin may range from 0.1 Pa-s to about 100 Pa-s, from 10.0 Pa-s to about 90 Pa-s. and from 0.4 Pa-s to about 80.0 Pa-s at 25° C.

Generally, the viscosity of precursor curable composition may range from 0.1 Pa-s to about 12.0 Pa-s at 50° C. In various embodiments, the viscosity of precursor curable composition may range from 0.1 Pa-s to about 12.0 Pa-s, from 0.2 Pa-s to about 8.0 Pa-s and from 0.4 Pa-s to about 4.0 Pa-s at 50° C.

Another beneficial property which the precursor curable composition possesses includes thermal stability which relates to less than 20% increase of viscosity over the period of 16 days when aged at 50° C. Generally, the thermal stability of the precursor curable composition as measured by an increased viscosity (from the original viscosity of the composition) may range from 0% to about 20%. In various embodiments, the thermal stability of the precursor curable composition may range from 0% to about 20%, from 2% to about 19% and from about 3% to about 18% when aged at 50° C. for 16 days. Above the about 20% range, the composition will tend to gel rapidly and gelling is an indication that the composition will not remain at its original viscosity at room temperature for a period longer than 16 days.

### (II) Processes for Producing the Precursor Curable Composition

Another aspect encompasses process for preparing the precursor curable composition. The process comprises admixing the following components: (a) at least one epoxy resin wherein the first epoxy resin may be a bisphenol F-type epoxy; and (b) at least one latent catalyst; and then heating the mixture at a temperature sufficient to mix the components and produce a precursor curable composition. Optionally, the precursor curable composition may further include (c) a curing catalyst, (d) an organic solvent, and (e) a second epoxy resin. Additional compounds may be added to the composition as known by the skilled artisan as described above.

All the compounds of the precursor curable composition are typically mixed and dispersed at a temperature enabling the preparation of an effective precursor curable composition having the desired balance of properties for a particular application. Generally, the temperature for mixing and dispersing of all components may range from −10° C. to about 80° C. In various embodiments, the temperature for mixing and dispersing of all components may range from −10° C. to about 80° C., from 0° C. to about 60° C., from 10° C. to about 50° C., or from 20° C. to about 40° C. Lower mixing temperatures help to minimize pre-reacting the epoxide in the precursor curable composition and to maximize the pot life of the precursor curable composition.

The preparation of the precursor curable composition, and/or any of the steps thereof, may be a batch or a continuous process. The mixing equipment used in the process may be any vessel and ancillary equipment well known to those skilled in the art.

### (III) Processes for Preparing a Cured Precursor Composite Material

Another aspect provides processes for preparing a cured precursor composite material or curing the precursor curable composition. The processes comprise providing a precursor curable composition and exposing the curable composition to heat to form a thermoset or a cured composite. Alternately, the precursor curable composition may be applied to an article, then exposing the curable composition to heat to form the prepreg precursor composite material, a thermoset, or a cured composite. Generally, the precursor curable composition may be applied to at least a portion of a surface of an article to be coated or impregnating the precursor curable composition to an article, prior to subjecting it to heat for curing.

### (a) Precursor Curable Composition

The precursor curable composition is detailed above.

### (b) Articles

In another aspect, disclosed herein are processes for preparing a cured precursor composite material. Additionally, processes disclosed herein encompass an article comprising a cured or uncured curable epoxy resin composition adhering to at least one portion of the substrate or impregnating the article. The article, in broad terms, may be defined as a material wherein the precursor curable composition is initially applied and adheres to at least a portion of at least one surface of the substrate. The article with the precursor curable composition may be formed into any known shape. The curable coating composition may be cured with or without an article by exposing the composition to heat to form a thermoset or cured composition. When the curable composition may be cured with an article, the coating may bond to the substrate.

In a further embodiment, the article may be a fiber. Non-limiting examples of fibers may be polyester, nylon, rayon, Kevlar, glass fibers, carbon fibers, Nomex, polyesters, and ultra-high molecular weight polyethylene, and combinations thereof. In a preferred embodiment, the fiber may be carbon fiber.

In various embodiments, the article may be in various configurations. Non-limiting configuration examples of the article may be a fiber, a roll, a sheet, a wire, a strand, a cloth, and combinations thereof. The configuration of the article may be of various dimensions, shapes, thicknesses, and weights.

### (c) Applying the Curable Composition

The process further comprises applying the curable epoxy resin composition to a portion of at least one surface of an article. Suitable articles are detailed above. Application of the curable coating composition may be applied through various means. For example, the coating composition may be applied using a drawdown bar, a roller, a knife, a paint brush, a sprayer, dipping, immersion, vacuum infiltration, or other methods known to the skilled artisan. As detailed above, the curable coating composition may be applied to one or more surfaces of the article to be coated.

### (d) Curing the Precursor Curable Composition

The process further comprises curing the precursor curable composition or curing the precursor curable composition to a portion of at least one surface of an article. The precursor curable composition may be cured by exposing the composition to heat for a predetermined period of time to form a cured precursor composite material, a cured composition, or a thermoset.

Generally, the reaction process for producing the cured precursor composite material includes carrying out the curing reaction at process conditions to enable the preparation of an effective cured precursor composite material having the desired balance of properties for a particular application, particularly for forming a carbon-carbon composite product. The reaction temperature to carry out the reaction process for preparing the cured precursor composite material may range from −10° C. to about 300° C. In various embodiments, reaction temperature may range from −10° C. to about 300° C., from 10° C. to about 280° C., from about 20° C. to about 260° C., and from 50° C. to 250° C.

Generally, the reaction pressure to carry out the reaction process for preparing the cured precursor composite material, the cured composition, or the thermoset may range from 1 psig (6.9 kPa) to about 150 psig (1,034.2 kPa). In various embodiments, the reaction pressure may range from 1 psig (6.9 kPa) to about 150 psig (1,034.2 kPa), from 5 psig (34.5 kPa) to about 80 psig (551.6 kPa), and from 10 psig (68.9 kPa) to about 20 psig (137.9 kPa).

The reaction time to carry out the reaction process for preparing the cured precursor composite material may range from 2 minutes (min) to about 90 days. In various embodiments, the reaction time may range from 2 minutes to about 90 days, from 3 minutes to about 30 days, from 4 minutes to about 7 days, from 5 minutes to about 1 day, from 6 minutes to about 8 hours, or from 7 minutes to about 4 hours.

The preparation of the cured precursor composite material, a prepreg, a cured composition, or a thermoset may be a batch or a continuous process. The equipment employed to carry out the reaction includes equipment known to those skilled in the art.

One of the beneficial consequences of producing the cured material from the precursor curable composition includes producing a cured product having a high carbon yield of generally at least about 50 wt %. Generally, the carbon yield of the cured product, as measured by TGA, may range from 50 wt % to about 95 wt %. In various embodiments, the carbon yield may range from 50 wt % to about 95 wt %, from 55 wt % to about 90 wt %, from 60 wt % to about 75 wt %, and from 52 wt % to about 62 wt % based on the total weight of the cured composition.

For producing the prepreg (i.e., the cured precursor composite material) wherein the prepreg has been prepared from an epoxy resin-based precursor curable composition without containing a solvent, the permissible temperature range for heating a phenol-formaldehyde epoxy novolac resin can be from about 70° C. to about 90° C. The heating of the precursor curable composition can be carried out prior to and during the addition of a latent catalyst and/or curing agent. The permissible range for mixing time of the precursor curable composition can be from about 5 minutes to about 48 hours in one embodiment. The mixing time can vary depending on the size/quantity (e.g., from about 0.005 kg to about 3 kg) of the prepared precursor curable composition.

For producing the prepreg wherein the prepreg has been prepared from an epoxy resin-based precursor curable composition containing a solvent, the permissible temperature rage for heating a phenol-formaldehyde epoxy novolac resin may be from 60° C. to about 70° C. The heating of the precursor curable composition may be carried out prior to and/or during the addition of the solvent to the precursor curable composition. In another embodiment, the permissible temperature range for a phenol-formaldehyde epoxy novolac resin in a solvent may be from about 25° C. to about 30° C. Generally, the permissible temperature range for a phenol-formaldehyde epoxy novolac resin in a solvent may range from 25° C. to about 70° C. In various embodiments, the permissible temperature may range from 25° C. to about 70° C., from 30° C. to about 60° C., or from 40° C. to about 50° C. The heating of the precursor curable composition may be carried out prior to and/or during the addition of the latent catalyst and/or curing agent. The permissible range for mixing time, in one embodiment, can be from about 5 min to about 24 hr. The mixing time may vary depending on the size/quantity (e.g., from about 0.005 kg to about 3 kg) of the precursor curable composition.

For producing the prepreg wherein the prepreg has been prepared from a medium viscosity epoxy-based composition containing bisphenol F epoxy resin or a mixture of bisphenol F epoxy resin and phenol-formaldehyde epoxy novolac resin, the permissible temperature range for heating a bisphenol F-type epoxy-based resin may be from about 65° C. to about 85° C. The heating of the precursor curable composition may be carried out prior to and/or during the addition the latent catalyst and/or curing agent. The permissible range for the mixing time may be from about 5 min to about 24 hr. The mixing time can vary depending on the size/quantity (e.g., from about 0.005 kg to about 3 kg) of the precursor curable composition.

### (IV) Carbonization of the Cured Precursor Composite Material

In another aspect, the process for carbonizing or pyrolyzing the cured precursor composite material. The process comprises the following steps: (a) preparing a precursor curable composition as described above; (b) impregnating a carbon fiber material with the precursor curable composition of step (a); (c) curing the carbon fiber material impregnated with the precursor curable composition of step (b) to form a cured precursor composite material (“prepreg”); and (d) carbonizing the prepreg of step (c) to form a carbon-carbon composite product, wherein the carbon yield of the precursor curable composition is at least about 50 wt % based on the amount of the cured precursor curable composition used in step (b), excluding the amount of carbon fiber material used in step (b).

One embodiment includes producing a carbon-carbon composite product or article from the prepreg described above. For example, carbonization of the prepreg may be carried out at a predetermined temperature and for a predetermined period of time sufficient to carbonize the prepreg to form a carbon-carbon composite product. The carbonization may be carried out in the presence of an inert atmosphere. Generally, the carbonization reaction process for producing the carbon-carbon composite of the present invention includes carrying out the carbonizing reaction at process conditions to enable the preparation of an effective carbon-carbon composite having the desired balance of properties for a particular application.

For example, the carbonization temperature for preparing the carbon-carbon composite product may range of from 30° C. to about 1,000° C. In various embodiments, the carbonizing temperature may range from 30° C. to about 1,000° C., from 250° C. to about 900° C. and from 300° C. to about 800° C.

For example, the reaction time to carry out the reaction process for preparing the carbon-carbon composite product may range from about 2 hours to about 90 days, from 4 hours to about 30 days, from 6 hours to about 14 days, from 10 hours to about 7 days, or from 12 hours to about 24 hours.

The preparation of the carbon-carbon composite product and/or any of the steps thereof, may be a batch or a continuous process. The equipment employed to carry out the reaction includes equipment known to those skilled in the art.

### (V) Properties of the Carbon-Carbon Composites

The carbon-carbon composites provide several beneficial properties including superior or comparable thermal, electrical, mechanical, and chemical properties of the low density material relative to high performance materials such as steel or titanium. Several factors influence the properties of carbon-carbon composites. For example, the type of matrix material used to bond carbon fibers as well as the type and amount of carbon fiber used are useful factors taken into account in determining the desired CCC properties. The increase in the adhesion of the carbon matrix to the carbon fiber is also a consideration as well as providing a material that is free of surface and internal defects. The typical properties of carbon-carbon composites, having a combination of matrix and carbon fiber types, are documented in Morgan, P. (2005), Properties of Carbon Fibers, Carbon Fibers and their Composites (pp 791-860). Boca Raton, Fla.: CRC Press.

The properties of the carbon-carbon composite provide many superior or comparable properties to other carbon-carbon composites. Generally, the density of the carbon-carbon composite may range from 1.5 g·cm⁻³ to about 1.8 g·cm⁻³. In various embodiments, the density of the carbon-carbon composite may range from 1.5 g·cm⁻³ to about 1.8 g·cm⁻³, from 1.5 g·cm⁻³ to about 1.6 g·cm⁻³, from 1.6 g·cm⁻³ to about 1.7 g·cm⁻³, or from 1.7 g·cm⁻³ to about 1.8 g·cm⁻³.

Another beneficial property of the carbon-carbon is the tensile strength. Generally, the tensile strength may range from 10 MPa to about 70 MPa. In various embodiments, the tensile strength of the carbon-carbon composite may range from 10 MPa to about 70 MPa, from 20 MPa to about 60 MPa, or from 30 MPa to about 50 MPa.

In general, the modulus of the carbon-carbon composite may range from 7 GPa and about 170 GPa. In various embodiments, the modulus may range from 7 GPa and about 170 GPa, from 20 GPa to about 140 GPa, from 50 GPa to about 120 GPa, or from 80 GPa to about 100 GPa.

Additionally, the compressive strength of the carbon-carbon composite may range from 100 MPa to about 160 MPa. In various embodiments, the compressive strength may range from 100 MPa to about 160 MPa, from about 120 MPa to about 150 MPa, or from 130 MPa to about 140 MPa.

Generally, the thermal conductivity may range from 20 W·m⁻¹·K⁻¹ to about 150 W·m⁻¹·K⁻¹. In various embodiments, the thermal conductivity may range from 20 W·m⁻¹·K⁻¹ to about 150 W·m⁻¹·K⁻¹, from 40 W·m⁻¹·K⁻¹ to about 130 W·m⁻¹·K⁻¹, from 60 W·m⁻¹·K⁻¹ to about 110 W·m⁻¹·K⁻¹, and from 80 W·m⁻¹·K⁻¹ to about 100 W·m⁻¹·K⁻¹.

The carbon-carbon composite provides a coefficient of thermal expansion ranging from 2.0 10-6° C. to about 4.5 10-6° C. In various embodiments, the coefficient of thermal expansion ranging from 2.0 10-6° C. to about 4.5 10-6° C., from 2.5 10-6° C. to about 4.0 10-6° C., and from 3.0 10-6° C. to about 3.5 10-6° C.

Other properties of the carbon-carbon composites are presented in the examples.

Some non-limiting examples of end-use applications wherein the carbon-carbon composite product of present invention may be braking systems including brake discs, pads, clutch plates, rotors and stators for high speed trains, racing cars, motorcycles, tanks, high performance and military aircrafts; nose-tips, re-entry heat-shields, rocket motor nozzles, wing leading edges, and rocket exit cones within the aerospace industry; gas turbine engine components such as turbine wheels, bearings and seals, valve guides, and pistons; implants for the biomedical industry; column packing in distillation columns, distillations trays and supports, sparger tubes, feed pipes, mist eliminators, thermo-wells, and pump impellers; dies and molds for hot pressing; insulate and components in furnace element construction.

### Definitions

When introducing elements of the embodiments described herein, the articles “a”, “an”, “the” and “said” are intended to mean that there are one or more of the elements. The terms “comprising”, “including” and “having” are intended to be inclusive and mean that there may be additional elements other than the listed elements.

The term “precursor” refers to a curable resin composition, means a liquid epoxy-based resin including a latent catalyst and optionally a curing catalyst and optionally organic solvent from about 0.1 Pa-s to about 100.0 Pa-s measured at 25° C. and from about 0.1 Pa-s to about 250.0 Pa-s measured at 50° C. used as the matrix in the fabrication of a carbon-carbon composite.

The term “vitreous carbon” refers to a carbon-based material having an isotropic, non-graphitizing, low crystalline carbon structure that is typically formed from the pyrolysis of a crosslinked thermosetting polymer at a pyrolysis temperature of from about 1,000° C. to about 3,000° C.

The term “carbon-carbon composite (CCC)” refers to a series of layered, woven carbon fiber reinforcements bonded together by a carbon matrix. The process of fabricating a carbon-carbon composite generally includes impregnating the layered, woven carbon fibers with a thermosetting resin composition. The resin impregnated carbon fibers are cured to make a green carbon composite, and then the green carbon composite is pyrolyzed (carbonized) to a temperature of about 1,000° C. or above to make the final carbon-carbon composite material.

The term “preform” refers to carbon fibers that are layered and shaped into specific shapes.

The term “carbonize”, “carbonizing”, “carbonization” or “pyrolyzing” refers to removing a significant portion of non-carbon elements from a composition by heating the composition at a temperature of 10° C./minute from about 25° C. to about 1,000° C. under an inert atmosphere such as nitrogen.

The term “carbon yield” refers to a cured composition, means the percent weight of carbon remaining from a cured sample of a carbon-containing composition treated at 10° C./minute from about 25° C. to about 1,000° C. under an inert atmosphere such as nitrogen as measured in the absence of optional organic solvents by thermogravimetric analysis (TGA). A “high carbon yield” herein, with reference to a cured composition, means of at least about 50% based on the total weight of the cured composition.

The terms “cure”, “curing” and “curable” refer to a composition, means a process by which the liquid resin precursor irreversibly converts to an insoluble, solid polymer network.

The term “latent catalyst” refers to a compound which reacts with the epoxide group of the aromatic epoxy resin to initiate curing and/or polymerization of an epoxy resin by epoxide homopolymerization at elevated temperatures such as 85 to 250° C. based on the DSC Tonset but does not cause significant viscosity growth at moderate temperatures such as 50° C.

The term “curing agent” refers to a compound bearing functional groups which react with the epoxide of the epoxy resin to effect curing and/or polymerization by condensation of the epoxide groups of the epoxy resin with the functional groups of the curing catalyst.

The term “high degree of aromaticity” refers to a composition, means two or more aromatic benzene groups in a thermosetting polymer repeating unit.

The term “thermal stability” refers to a composition, means a maximum viscosity increase of no more than 20% over the course of 16 days when the resin composition is aged at 50° C.

The term “capability to cyclize” refers to a composition, means the condensation of saturated and unsaturated hydrocarbons within a cross linked polymeric structure of a cured thermosetting resin precursor to generate an extended graphitic structure.

The term “interfacial bonding” refers to the measurement of the interfacial shear strength in a 3-point bend which can be used to quantify how strongly a resin matrix bonds to a carbon fiber.

The term “shrinkage matching” refers to a process during pyrolysis in which a fiber and a resin matrix shrink at different amounts and at different rates which often leads to interfacial and/or matrix cracking. The fiber shrinks more than the resin. Pre-treating the fiber (e.g., via heat) prior to impregnation with the resin matrix induces an unquantified amount of shrinkage and oxidizes the fiber surface to improve interfacial bonding to promote better adhesion between the fiber and the resin matrix as well to reduce the difference in the shrinkage amount and the shrinkage rate during pyrolysis.

Having described the invention in detail, it will be apparent that modifications and variations are possible without departing from the scope of the invention defined in the appended claims.

### EXAMPLES

The following examples illustrate various embodiments of the invention. In the following Examples, various materials, terms and designations are used such as for example the following:

D.E.N. 438 epoxy novolac resin is a phenol-formaldehyde epoxy novolac resin and commercially available from The Dow Chemical Company.

D.E.R. 354 epoxy resin is a bisphenol F epoxy resin and commercially available from The Dow Chemical Company.

BCl₃-DMOA, a Lewis acid complex, stands for boron trichloride-N,N-dimethyloctylamine adduct.

BF₃-MEA, a Lewis acid complex, stands for boron trifluoride monoethyl amine adduct.

BDMA, tertiary amine, stands for dimethylbenzylamine.

“DAY 00” is the first day of viscosity measurement.

“MPTS” stands for methyl para-toluene sulfonate.

In the following Examples, standard analytical equipment and methods are used to measure properties including for example, the following:

### Differential Scanning Calorimetry Measurements

Differential scanning calorimetry (DSC) is performed using a Texas Instruments DSC Q200 differential scanning calorimeter. DSC baseline onset temperature (Tonset), which is taken as the temperature at which the thermogram deviates from the initial baseline, and exotherm of reaction (ΔH) is determined using a temperature ramp with a heating rate of 10° C./minute from 25° C. to 300° C. The samples are taken from the untreated liquid epoxy resin precursor curable composition.

Thermo Gravimetric Analysis Measurements

Thermo gravimetric analysis (TGA) is performed using a Texas Instruments TGA Q5000 thermo gravimetric analyzer. The carbon yield is determined using a temperature ramp of 10° C./min from 30° C. to 1,000° C. The carbon yield is taken as the percent of material by weight remaining after reaching 1,000° C. The samples for analysis are taken from a cured specimen.

Viscosity

The viscosity of the resin composition is measured using a Texas Instruments AR2000 EX rheometer equipped with a 60 mm 1° steel cone while employing a 25 μm gap at 25° C. or 50° C.

### Composition Example 1: Preparation of a Medium Viscosity Precursor Curable Composition for Fabrication of a Carbon-Carbon Composite Product by Impregnation

Process One

Step 1: Add a warm (heated at about 70° C. for about 24 hours (hr) in an oven) neat bisphenol F epoxy resin or a mixture of bisphenol F epoxy resin and phenol-formaldehyde epoxy novolac resin to a vessel;

Step 2: Add a latent catalyst to the epoxy resin of Step 1 while stirring: and

Step 3: Add a curing agent to the mixture of Step 2 and stir the mixture for a minimum of 5 minutes (min) to ensure homogeneity of the resulting precursor curable composition.

Process Two

Step 1: Prepare a cured precursor composite material and a carbon-carbon composite product by liquid impregnation, as described in WIPO Patent WO2013/188051A, incorporated herein by reference, using the medium viscosity precursor curable composition from Process One above.

### Composition Example 2: Preparation of a Precursor Curable Composition for Fabrication of a Carbon-Carbon Composite by High Viscosity, Tacky Prepreg Preparation

Part A: Solvent-Free Precursor Curable Composition for Hot Melt Impregnation

Process One

Step 1: Add a warm (heated at about 70° C. for about 24 hr in an oven) neat phenol-formaldehyde epoxy novolac resin of a particular molecular weight, or a mixture resins of different molecular weights, to a vessel;

Step 2: Add a latent catalyst to the resin of Step 1 at about 65° C. while stirring; and

Step 3: Add a curing agent to the mixture of Step 2 and stir the mixture for about 5 min to about 60 min while maintaining the temperature of the mixture at about 65° C. to form a resulting precursor curable composition.

Process Two

Step 1: Heat the precursor curable composition to a sufficient temperature to reduce the initial viscosity of the precursor curable composition;

Step 2: Prepare prepreg sheets by impregnating the carbon fibers with the heated precursor curable composition of Step 1 such that the resin uptake by the carbon fibers is about 65 wt % as described in U.S. Pat. No. 4,329,387, incorporated herein by reference;

Step 3: Layer the prepreg sheets from Step 2 to fabricate a prepreg laminate;

Step 4: Cure the prepreg laminate of Step 3 to form a cured precursor composite material; and

Step 5: Carbonize the cured precursor composite material from Step 4 to produce a carbon-carbon composite product.

Part B: Organic Solvent-Based Precursor Curable Composition for Room Temperature Impregnation

Process One

Step 1: Add an organic solvent and a warm (70° C. in oven for 24 hr) a neat phenol-formaldehyde epoxy novolac resin of a particular molecular weight; or add an organic solvent and a warm neat phenol-formaldehyde epoxy novolac resin of a mixture of molecular weights, to a vessel while stirring for a minimum of 10 min to ensure homogeneity. Optionally, a neat phenol-formaldehyde epoxy novolac resin containing a desired organic solvent can be added to a vessel at room temperature (about 25° C.);

Step 2: Add a latent catalyst to the resin of Step 1 while stirring and maintaining the temperature of the resin at 25° C.; and

Step 3: Add a curing agent to the mixture of Step 2 and stir the resulting mixture for a minimum of 15 min while maintaining the temperature of the mixture at 25° C.; and

Alternative Step 1: Alternative to the above Step 1, an organic solvent can be added to the warm mixture (70° C. in oven for 30 min) of neat phenol-formaldehyde epoxy novolac resin in a vessel while stirring for a minimum of 10 min.

Process Two

Step 1: Impregnate carbon fibers with the precursor curable composition such that the resin uptake is at least 65 wt % (as described in U.S. Pat. No. 4,329,387, incorporated herein by reference);

Step 2: Evaporate the solvent of the impregnated carbon fibers of Step 1 by drying the impregnated carbon fibers in an oven at 70° C. for at least 1 hr to form a prepreg sheet;

Step 3: Layer a predetermined number of prepreg sheets to fabricate a prepreg laminate;

Step 4: Cure the prepreg laminate of Step 3 to form a cured precursor composite material; and

Step 5: Carbonize the cured precursor composite material of Step 4 to make a carbon-carbon composite product.

### Cure Composition Example 1—Cure Schedule for the Bisphenol F Type Precursor Curable Composition

Part A: Preparation of Cured Precursor Curable Composition Clear Cast Plaques

Step 1: Add the precursor curable composition to a desired molding apparatus;

Step 2: Place the mold including the precursor curable composition in a convection oven equipped with an air venting system;

Step 3: (a) For precursor curable compositions including the Lewis acid complex, BF₃-MEA, as the curing agent, cure the mold according to cure schedule in Table I. (b) For precursor curable compositions including the Lewis acid complex or tertiary amine as the curing agent, and/or alkylating ester of para-toluene sulfonate as the latent catalyst, cure the mold according to cure schedule in Table II; and

Step 4: Equilibrate the molding apparatus at room temperature prior to removing from the oven.

TABLE I
Cure Schedule for Bisphenol F-Type Epoxy
Resin Compositions with BF₃-MEA

| Temper- | Heat Rate | Final | Hold | Total | Cumulative |
|---|---|---|---|---|---|
| ature | (° C./ | Temperature | Time | Time | Time |
| (° C.) | minute) | (° C.) | (hours) | (hours) | (hours) |
| 60 | 12 | 120 | 3 | 3.1 | 3.1 |
| 120 | 1 | 200 | 1 | 2.3 | 5.4 |

TABLE II
Cure Schedule for Bisphenol F-Type Epoxy Resin
Compositions with BCl₃-DMOA, BDMA, or MPTS

| Temper- | Heat Rate | Final | Hold | Total | Cumulative |
|---|---|---|---|---|---|
| ature | (° C./ | Temperature | Time | Time | Time |
| (° C.) | minute) | (° C.) | (hours) | (hours) | (hours) |
| 60 | 5 | 100 | 0.5 | 0.6 | 0.6 |
| 100 | 1 | 150 | 0.5 | 1.3 | 2.0 |
| 150 | 1 | 160 | 0.5 | 0.7 | 2.6 |
| 160 | 1 | 170 | 0.5 | 0.7 | 3.3 |
| 170 | 1 | 180 | 4 | 4.2 | 7.5 |
| 180 | 1 | 185 | 1 | 1.1 | 8.6 |
| 185 | 1 | 190 | 1 | 1.1 | 9.6 |
| 190 | 1 | 195 | 1 | 1.1 | 10.7 |
| 195 | 1 | 200 | 5 | 5.1 | 15.8 |

Part B: Preparation of a Cured Carbon Composite Including the Precursor Curable Composition

Step 1: Assemble the precursor curable composition prepreg molding plates and place in a compression molder; and

Step 2: Cure the precursor curable composition prepreg in a compression molder according to the cure schedule in Table III.

TABLE III
Compression Molding Cure Schedule for
Precursor Curable Composition Prepreg

| | Heat | | | | | |
|---|---|---|---|---|---|---|
| | Rate | Final | | Hold | Total | Cumulative |
| Temperature | (° C./ | Temperature | Force | Time | Time | Time |
| (° C.) | min) | (° C.) | (lbs) | (hr) | (hr) | (hr) |
| 25 | 1 | 100 | 100 | 1 | 2.3 | 2.3 |
| 100 | 1 | 150 | 100 | 1 | 1.8 | 4.1 |
| 150 | 1 | 170 | 100 | 3 | 3.3 | 7.4 |
| 170 | 1 | 185 | 100 | 3 | 3.3 | 10.7 |
| 185 | 1 | 190 | 100 | 7 | 7.1 | 17.8 |
| 25 | 1 | 100 | 100 | 1 | 2.3 | 20.1 |

### Post Cure Composition Example 1—Post Cure Schedule for the Bisphenol F Type Precursor Curable Composition

Part A: Preparation of Post Cured Precursor Curable Composition Clear Cast Plaques

Step 1: After removing the molding apparatus containing the precursor curable composition, made with the Lewis acid complex or tertiary amine as the curing agent, and/or alkylating ester of para-toluene sulfonate as the latent catalyst, from the oven, place the molding apparatus with the precursor curable composition back into a convection oven and post cure according to the post cure schedule in Table IV.

Part B: Preparation of a Post Cured Carbon Composite Including the Precursor Curable Composition

Step 1: After removing the molding apparatus containing the precursor curable composition from the compression molder, place the molding apparatus containing the precursor curable composition into a convection oven and post cure according to the post cure schedule in Table IV.

TABLE IV
Post Cure Schedule for Bisphenol F-Type Resin Compositions

| Temper- | Heat Rate | Final | Hold | Total | Cumulative |
|---|---|---|---|---|---|
| ature | (° C./ | Temperature | Time | Time | Time |
| (° C.) | minute) | (° C.) | (hour) | (hour) | (hour) |
| 200 | — | 200 | 1 | 1 | 1 |
| 200 | 1 | 210 | 0.5 | 0.7 | 1.7 |
| 210 | 1 | 220 | 0.5 | 0.7 | 2.3 |
| 220 | 1 | 230 | 0.5 | 0.7 | 3.0 |
| 230 | 2 | 240 | 0.5 | 0.6 | 3.6 |
| 240 | 2 | 250 | 0.5 | 0.6 | 4.2 |
| 250 | 2 | 260 | 0.5 | 0.6 | 4.8 |
| 260 | 2 | 280 | 0.5 | 0.7 | 5.4 |
| 280 | 2 | 300 | 0.5 | 0.7 | 6.1 |

### Comparative Examples A-N

In Table V, comparative resin compositions (Comparative Examples A and B) were prepared with a phenol-formaldehyde epoxy novolac resin, D.E.N. 438 epoxy novolac (commercially available from The Dow Chemical Company), with a Lewis acid complex, BF₃-MEA, as described by Mackay (Sandia Labs Report (1969) SC-RR-68-651), incorporated herein by reference.

Additionally, comparative resin compositions (Comparative Examples C and D) in Table V were prepared with a phenol-formaldehyde epoxy novolac resin, D.E.N. 438 epoxy novolac resin with a tertiary amine, BDMA, and a Lewis acid complex, BCl₃-DMOA.

Additionally, comparative resin compositions (Comparative Examples E and F) in Table VI were prepared using a bisphenol F epoxy resin, D.E.R. 354 (commercially available from The Dow Chemical Company), with a Lewis acid complex, BF₃-MEA, which was utilized for the cure and carbonization of D.E.N. 438 as mentioned above.

Additional comparative resin compositions (Comparative Examples G and H) in Table VI were prepared using bisphenol F epoxy resin D.E.R. 354 epoxy resin with a tertiary amine, BDMA, and a Lewis acid complex, BCl₃-DMOA.

All comparative resin compositions, as described in Tables V and VI, were prepared according to Process One described above in Composition Examples 2 and 1, respectively. The Lewis acid complexes BCl₃-DMOA and BF₃-MEA were melted at 60° C. and 80° C., respectively, in a small (100 mL) glass vial for a few hours (2 hr) prior to mixing with the bisphenol F-type epoxy resin. DSC was used to obtain the baseline onset temperature (Tonset) and reaction exotherm of reaction (ΔH) of the resulting liquid at a temperature of from about 25° C. to about 300° C. at 10° C./minute (° C./min).

A 5 gram (g) portion of each of the resins of Comparative Examples A, B, E, F, was cured and post cured in an aluminum (Al) pan (0.05 m diameter) as described in Tables I and IV, while a 5 g portion of each of the resins of Comparative Examples C, D, G, and H was cured and post cured in an Al pan (0.05 m diameter) as described in Tables II and IV.

A portion (11 mg) of the resultant cured resins of each of the Comparative Examples A-H was carbonized in a Thermogravimetric Analysis instrument (TA Q5000) at a temperature of from about 30° C. to about 1,000° C. at 10° C./min.

A useful precursor curable composition requires a carbon yield of greater than or equal to about 50%. Comparative Examples A, C, and D described in Table V, illustrate that the carbon yield of each of such comparative examples was not greater than or equal to 50% required for a useful precursor curable composition. The carbon yield of Comparative Example B exceeds 50%, however, the thermal stability of Comparative Example B in Table VII is not satisfactory for a useful precursor curable composition.

TABLE V
DSC Tₒₙₛₑₜ, Exotherm, and Carbon Yield for Phenol-Formaldehyde
Epoxy Novolac Resin (D.E.R. 438) Comparative Compositions

| Compar- | D.E.N. | Curing | DSC | DSC | Carbon |
|---|---|---|---|---|---|
| ative | 438 | Agent | Tₒₙₛₑₜ | ΔH | Yield |
| Example | (g, wt %) | (g, wt %) | (° C.) | (J/g) | (%) |
| A | 9.72, 97.2 | BF₃-MEA | 80 | 340 | 44 |
| | | 0.28, 2.8 | | | |
| B | 9.47, 94.6 | BF₃-MEA | 78 | 460 | 52 |
| | | 0.54, 5.4 | | | |
| C | 9.80, 98.0 | BCl₃-DMOA | 105 | 191 | 33 |
| | | 0.21, 2.1 | | | |
| D | 9.80, 98.0 | BDMA | 59 | 49 | 3 |
| | | 0.20, 2.0 | | | |

Comparative Examples E, F, G, and H described in Table VI did not exhibit a carbon yield of greater than or equal to 50% required for a useful precursor curable composition.

TABLE VI
DSC Tₒₙₛₑₜ, Exotherm, and Carbon Yield for Bisphenol
F Epoxy Resin (D.E.R. 354) Comparative Compositions

| Compar- | D.E.R. | Curing | DSC | DSC | Carbon |
|---|---|---|---|---|---|
| ative | 354 | Agent | Tₒₙₛₑₜ | ΔH | Yield |
| Example | (g, wt %) | (g, wt %) | (° C.) | (J/g) | (%) |
| E | 9.72, 97.1 | BF₃-MEA | 78 | 477 | 30 |
| | | 0.29, 2.9 | | | |
| F | 9.46, 94.3 | BF₃-MEA | 80 | 498 | 41 |
| | | 0.57, 5.6 | | | |
| G | 9.80, 98.0 | BCl₃-DMOA | 101 | 187 | 15 |
| | | 0.20, 2.0 | | | |
| H | 9.80, 98.0 | BDMA | 56 | 19 | 7 |
| | | 0.20, 2.0 | | | |

Comparative resin compositions (Comparative Example I, J, and K) were prepared with a bisphenol F epoxy resin, D.E.R. 354, with a Lewis acid complex

BCl₃-DMOA, BF₃-MEA, and BDMA, as described in Table VII; and according to Process One described above in Composition Example 1. The Lewis acid complexes BCl₃-DMOA and BF₃-MEA were each melted at 60° C. and 80° C., respectively, in small (100 mL) glass vials for a few hours (about 2 hr) prior to mixing with the bisphenol F epoxy resin.

The isothermal 25° C. viscosity of samples (1 g) of the comparative examples were obtained after mixing (DAY00) on an AR2000EX instrument supplied by TA Instruments using a 60 millimeter (mm) 1° steel cone plate with a 25 micron (μm) gap. The samples were placed in a convection oven at 50° C. Periodically, the samples were removed from the oven, allowed to equilibrate to 25° C. and the 25° C. viscosity was obtained using the aforementioned method.

With the Lewis acid complex and tertiary amine as the curing agent, the viscosity build exceeded 20% when Comparative Examples I-K described in Table VII were aged at 50° C. for 16 days. The thermal stability of the compositions with the phenol-formaldehyde epoxy novolac resin was not obtained. However, a similar thermal stability is expected when compositions with bisphenol F epoxy resin and a curing agent in Comparative Examples I-K (Table VII) is replaced with phenol-formaldehyde epoxy novolac resin. This assumption is based on the similar DSC ΔH data of compositions with phenol-formaldehyde novolac epoxy resin and a curing agent in Comparative Examples A-D (Table V) and compositions with bisphenol F epoxy resin and a curing agent in Comparative Examples E-H (Table VI).

TABLE VII
Viscosity of Comparative D.E.R. 354 Bisphenol F Epoxy Resin Samples
after 50° C. Oven Aging

| | | | Viscosity (Pa · s, 25° C.) after 50° C. Oven | | | |
|---|---|---|---|---|---|---|
| | | Curing | Aging | | | |
| Comparative | D.E.R. 354 | Agent | (% Viscosity Increase vs. Day 00) | | | |
| Example | (g, wt %) | (g, wt %) | DAY 00 | DAY 04 | DAY 08 | DAY 16 |
| I | 19.44, 97.1 | BF₃-MEA | 4.83 | 452.80 | 1019.00 | Gelled |
| | | 0.57, 2.9 | | (9284) | (21019) | |
| J | 19.60, 98.0 | BCl₃- | 3.89 | 4.11 | 4.37 | 4.85 |
| | | DMOA | | (5) | (12) | (25) |
| | | 0.40, 2.0 | | | | |
| K | 19.60, 98.0 | BDMA | 6.50 | Gelled | Gelled | Gelled |
| | | 0.40, 2.0 | | | | |

Comparative resin composition (Comparative Example L) described in Table VIII was prepared using a phenol-formaldehyde epoxy novolac resin, D.E.N. 438, with a Lewis acid complex, BF₃-MEA, and an alkylating ester of para-toluene sulfonate as the latent catalyst, MpTS.

Additionally, a comparative resin composition (Comparative Example M) described in Table IX was prepared using a bisphenol F epoxy resin, D.E.R. 354, with a Lewis acid complex, BF₃-MEA, and an alkylating ester of para-toluene sulfonate as the latent catalyst, MpTS.

An additional comparative resin composition (Comparative Example N) described in Table X was prepared using a bisphenol F epoxy resin, D.E.R. 354, with a Lewis acid complex, BF₃-MEA, and an alkylating ester of para-toluene sulfonate as the latent catalyst, MpTS.

The comparative resin composition, as described in Table VIII, was prepared according to Process One described above in Composition Example 2. The comparative resin compositions, as described in Tables IX and X, were prepared according to Process One described above in Composition Example 1. The Lewis acid complex BF₃-MEA was melted at 80° C. in a small (100 mL) glass vial for a few hours (about 2 hr) prior to mixing with the bisphenol F-type epoxy resin.

DSC was used to obtain the baseline onset temperature (Tonset) and reaction exotherm of reaction (ΔH) of the resulting liquid at a temperature of from about 25° C. to about 300° C. at 10° C./min.

A 5 gram (g) portion of each of the resins of Comparative Examples L and M were cured and post cured in an aluminum (Al) pan (0.05 m diameter) as described in Tables I and IV.

A portion (11 mg) of the resultant cured resins of each of the Comparative Examples L and M was carbonized in a Thermogravimetric Analysis instrument (TA Q5000) at a temperature of from about 30° C. to about 1,000° C. at 10° C./min.

The isothermal 25° C. viscosity of a sample (1 g) of the Comparative Example N was obtained after mixing (DAY00) on an AR2000EX instrument supplied by TA Instruments using a 60 millimeter (mm) 1° steel cone plate with a 25 micron (μm) gap. The sample was placed in a convection oven at 50° C. Periodically, a sample was removed from the oven, allowed to equilibrate to 25° C. and the 25° C. viscosity was obtained using the aforementioned method.

As described in Table VIII, Comparative Example L, which consists of a bisphenol F epoxy resin, a curing agent, and an alkylating ester of para-toluene sulfonate, has a satisfactory carbon yield of 56%. However, the thermal stability of a similar composition in Comparative Example M (Table IX) shows that this composition is not satisfactory for use as a precursor curable composition of the present invention. It is observed that the viscosity build at 50° C. up to day 8 for Comparative Example N described in Table IX is greater than Comparative Example I described in Table VII. The composition of Comparative Example I consists of bisphenol F epoxy resin, D.E.R. 354, and a curing agent BF₃-MEA; while the composition of Comparative Example N consists of bisphenol F epoxy resin, D.E.R. 354, a curing agent BF₃-MEA, and latent catalyst, MPTS. This comparison illustrates that the latent catalyst reduced the viscosity build when the sample was aged at 50° C. up to 8 days. Additionally, comparison of the above comparative examples teach that a satisfactory carbon yield significantly greater than 50% is achieved when a latent catalyst is included with the curing agent, however, “fine tuning” the amount of the latent catalyst and curing agent is necessary to achieve the desired thermal stability.

TABLE VIII
DSC Tonset, Exotherm, and Carbon Yield for Bisphenol F Epoxy Resin
(D.E.R. 354) Comparative Compositions

| Comparative | D.E.R. 354 | Curing Agent | MpTS | DSC Tₒₙₛₑₜ | DSC ΔH | Carbon Yield |
|---|---|---|---|---|---|---|
| Example | (g, wt %) | (g, wt %) | (g, wt %) | (° C.) | (J/g) | (%) |
| L | 9.26, 92.3 | BF₃-MEA | 0.6, 6.0 | 86 | 390 | 56 |
| | | 0.17, 1.7 | | | | |

TABLE IX
Viscosity of Comparative D.E.R. 354 Bisphenol F Epoxy Resin Samples after
50° C. Oven Aging

| | | Curing | | Viscosity (Pa · s, 25° C.) after 50° C. | | | |
|---|---|---|---|---|---|---|---|
| Comparative | D.E.R. 354 | Agent | MpTS | Oven Aging (% Viscosity Increase vs. Day 00) | | | |
| Example | (g, wt %) | (g, wt %) | (g, wt %) | DAY 00 | DAY 04 | DAY 08 | DAY 16 |
| M | 18.52, 92.5 | BF₃-MEA | 1.22, 6.1 | 2.68 | 17.59 | 103.90 | Gelled |
| | | 0.29, 1.4 | | | (558) | (3784) | |

Comparative Example N described in Table X has a satisfactory carbon yield of 56% but the thermal stability of Comparative Example N is assumed to be unsatisfactory. The thermal stability of Comparative Example N was not measured. The thermal stability of Comparative Example N is assumed to be similar to Comparative Example M. Comparative Example N consists of the phenol-formaldehyde epoxy novolac resin, D.E.N 438, curing agent BF₃-MEA, and latent catalyst, MPTS; while Comparative Example M consists of the bisphenol F epoxy resin, D.E.R 354, curing agent BF₃-MEA, and latent catalyst, MPTS. The above assumption is based on the similarity of the DSC ΔH Comparative Example L, a composition consisting of the bisphenol F epoxy resin, D.E.R 354, curing agent BF₃-MEA, and latent catalyst, MPTS; and Comparative Example N, consisting of the phenol-formaldehyde epoxy novolac resin, D.E.N 438, curing agent BF₃-MEA, and latent catalyst, MPTS.

TABLE X
DSC Tₒₙₛₑₜ, Exotherm, and Carbon Yield for Phenol-Formaldehyde Epoxy
Novolac Resin (D.E.R. 438) Comparative Compositions

| Comparative | D.E.N. 438 | Curing Agent | MpTS | DSC Tₒₙₛₑₜ | DSC ΔH | Carbon Yield |
|---|---|---|---|---|---|---|
| Example | (g, wt %) | (g, wt %) | (g, wt %) | (° C.) | (J/g) | (%) |
| N | 9.26, 92.4 | BF₃-MEA | 0.62, 6.2 | 87 | 342 | 56 |
| | | 0.14, 1.4 | | | | |

### Examples 1-8: Carbon Yields, DSC Onset Temperature, and Reaction Exotherm of Bisphenol F-Type Epoxy Resins with Curing Agent and/or Latent Catalyst

A resin composition was prepared with a bisphenol F-type epoxy resins, D.E.R. 354 or D.E.N. 438; tertiary amine, BDMA, or Lewis acid complex, BF₃-DMOA as the curing agent; and an alkylating ester of para-toluene sulfonate, MPTS, as the latent catalyst as described in the Tables XI and (Examples 1 and 2) and XII (Examples 5 and 6) and according to Process One described above in Composition Examples 1 and 2, respectively.

Alternatively, a resin composition was prepared with a bisphenol F-type epoxy resins, D.E.R. 354 or D.E.N. 438, with an alkylating ester of para-toluene sulfonate as the latent catalyst as described in Tables XI (Examples 3 and 4) XII (Examples 7 and 8).

The Lewis acid complex BCl₃-DMOA was melted at 60° C. in a small (100 mL) glass vial for a few hours (about 2 hr), prior to mixing with the bisphenol F-type epoxy resins. DSC was used to obtain the baseline onset temperature (Tonset) and exotherm of reaction (ΔH) of the liquid at a temperature of from about 25° C. to about 300° C. at 10° C./min.

A 5 g portion of each of Examples 1-4 was cured and post cured according to Tables II; and a 5 g portion of each of Examples 5-8 was cured and post cured according to Table IV. A portion of each of the cured examples (11 mg) was carbonized in a thermogravimetric analysis instrument (TA Q5000) at a temperature of from about 30° C. to about 1,000° C. at 10° C./min.

The carbon yields of Comparative Examples E, F, G, and H as described in Table VI, ranged from about 7% to about 41%, respectively. The Comparative Examples E, F, G, and H consisted of bisphenol F epoxy resin, D.E.R. 354, and a Lewis acid curing agent.

By using an alkylating ester of para-toluene sulfonate as the latent catalyst in the compositions of the present invention instead of a Lewis acid curing agent; or by using an alkylating ester of para-toluene sulfonate as the latent catalyst blended with a Lewis acid curing agent, a carbon yield of at least about 50% was achieved for the precursor curable compositions containing bisphenol F epoxy resin, as illustrated by Examples 1-4 described in Table XI.

TABLE XI
DSC Tₒₙₛₑₜ, Exotherm, and Carbon Yield of Inventive Examples with D.E.R.
354 Bisphenol F Epoxy Resin

| | D.E.R. 354 | Curing Agent | MPTS | DSC Tₒₙₛₑₜ | DSC ΔH | Carbon Yield |
|---|---|---|---|---|---|---|
| Example | (g, wt %) | (g, wt %) | (g, wt %) | (° C.) | (J/g) | (%) |
| 1 | 9.40, 93.9 | BCl₃-DMOA | 0.50, 5.0 | 104 | * | 57 |
| | | 0.11, 1.1 | | | | |
| 2 | 9.30, 93.0 | BDMA | 0.60, 6.0 | 138 | * | 57 |
| | | 0.10, 1.0 | | | | |
| 3 | 9.01, 90.0 | — | 1.00, 10.0 | 228 | * | 61 |
| 4 | 8.80, 88.0 | — | 1.21, 12.1 | 220 | * | 61 |

* Exothermic reaction not complete

The carbon yields of Comparative Examples A, B, C and D in Table V, ranged from about 3% to about 52%, respectively. Comparative Examples A, B, C and D consisted of the phenol-formaldehyde epoxy novolac resin, D.E.N. 438, and a Lewis curing agent.

By using a latent catalyst instead of the Lewis acid curing agent; or by using the alkylating ester of para-toluene sulfonate as the latent catalyst blended with the Lewis acid curing agent, a carbon yield of from at least about 50% was achieved for the precursor curable compositions with the phenol-formaldehyde epoxy novolac resin, as illustrated by Examples 5-8 in Table XII.

TABLE XII
DSC Tₒₙₛₑₜ, Exotherm, and Carbon Yield of Inventive Examples with D.E.N.
438 Epoxy Novolac Resin

| | D.E.N. 438 | Curing Agent | MPTS | DSC Tₒₙₛₑₜ | DSC ΔH | Carbon Yield |
|---|---|---|---|---|---|---|
| Example | (g, wt. %) | (g, wt %) | (g, wt %) | (° C.) | (J/g) | (%) |
| 5 | 9.40, 93.9 | BCl₃-DMOA | 0.50, 5.0 | 116 | * | 56 |
| | | 0.11, 1.1 | | | | |
| 6 | 9.30, 93.0 | BDMA | 0.61, 6.1 | 146 | 645 | 59 |
| | | 0.10, 1.0 | | | | |
| 7 | 9.00, 90.0 | — | 1.00, 10.0 | 223 | 539 | 59 |
| 8 | 8.80, 88.0 | — | 1.20, 12.0 | 212 | 709 | 61 |

* Exothermic reaction not complete

### Examples 9-14: Thermal Stability of Bisphenol F-Type Epoxy Resins with Curing Agent and/or Latent Catalyst

A resin composition was prepared with bisphenol F epoxy resin, D.E.R. 354, a tertiary amine or a Lewis acid complex as the curing agent, and an alkylating ester of para-toluene sulfonate as the latent catalyst as described in Table XIII for Examples 9-12 and according to Process One under Composition Example 1.

Alternatively, a resin composition was prepared with a bisphenol F-type epoxy resin, D.E.R. 354 or D.E.N. 438, and an alkylating ester of para-toluene sulfonate as the latent catalyst as described in Table XIII for Examples 13 and 14; and according to Process One under Composition Example 1

The Lewis acid complex BCl₃-DMOA was melted at a temperature of 60° C. in a small (100 mL) glass vial for a few hours (about 2 hr), prior to mixing with the DOW bisphenol F epoxy resin. The isothermal 25° C. viscosity of the samples (1 g) were obtained after mixing (DAY00) on an AR2000EX instrument using a 60 mm 1° steel cone plate with a 25 μm gap. The samples were placed in a convection oven at 50° C. Periodically, the samples were removed from the oven, allowed to equilibrate to 25° C. and the 25° C. viscosity was obtained using the aforementioned method.

The viscosity build of Comparative Examples I-K described in Table VII including bisphenol F epoxy resin with a Lewis acid curing agent and Comparative Example M in Table IX including bisphenol F epoxy resin with a Lewis acid curing agent as well as an alkylating ester of para-toluene sulfonate as the latent catalyst when aged at 50° C. for 16 days; exceeded 20%. By incorporating the alkylating ester of para-toluene sulfonate as the latent catalyst with the Lewis acid curing agent or alternatively using just the alkylating ester of para-toluene sulfonate as the latent catalyst alone with the bisphenol F epoxy resin in the precursor curable composition in the Table XIII Examples 9-14, the viscosity build does not exceed 20% when aged at 50° C. for 16 days.

The Lewis acid curing agent, used in Comparative Example M described in Table IX may be used in a precursor curable composition by lowering the amount of the Lewis acid complex, BF₃-MEA used in the composition. Because the composition of Comparative Example M contains bisphenol F epoxy resin, BF₃-MEA as the curing agent, and an alkylating ester of para-toluene sulfonate as the latent catalyst, the carbon yield is at least about 50%. Based on similar DSC data for Examples 1-4 described in Table XI and Examples 5-8 described in Table XII, the thermal stability for precursor curable compositions containing the phenol-formaldehyde epoxy novolac resin should be similar to identical compositions containing the bisphenol F epoxy resin.

The compositions of Examples 1-4 include bisphenol F epoxy resin, with a Lewis acid complex or tertiary amine as the curing agent, and an alkylating ester of para-toluene sulfonate as the latent catalyst; while the compositions of Examples 5-8 include a phenol-formaldehyde epoxy novolac resin, a Lewis acid complex or tertiary amine as the curing agent, and an alkylating ester of para-toluene sulfonate as the latent catalyst.

TABLE XIII
Viscosity of D.E.R. 354 Bisphenol F Epoxy Resin Samples After 50° C. Oven
Aging.

| | | | | Viscosity (Pa · s, 25° C.) | | | |
|---|---|---|---|---|---|---|---|
| | | Curing | | after 50° C. Oven Aging | | | |
| | D.E.R. 354 | Agent | MPTS | (% Viscosity Increase vs Day00) | | | |
| Example | (g, wt %) | (g, wt %) | (g, wt %) | DAY00 | DAY04 | DAY08 | DAY16 |
| 9 | 18.80, 94.0 | BCl₃-DMOA | 1.01, 5.1 | 2.58 | 2.70 | 2.67 | 2.71 |
| | | 0.20, 1.0 | | | (5) | (3) | (5) |
| 10 | 18.60, 93.0 | BDMA | 1.20, 6.0 | 3.58 | 3.64 | 3.57 | 3.54 |
| | | 0.20, 1.0 | | | (2) | (0) | (−1) |
| 11 | 18.40, 92.0 | BDMA | 1.20, 6.0 | 4.96 | 4.94 | 4.82 | 5.24 |
| | | 0.40, 2.0 | | | (0) | (−3) | (6) |
| 12 | 17.4, 87.0 | BDMA | 2.40, 12.0 | 2.07 | 2.21 | 2.14 | 2.41 |
| | | 0.20, 1.0 | | | (7) | (4) | (17) |
| 13 | 18.00, 90.0 | — | 2.01, 10.0 | 1.81 | 1.84 | 1.83 | 1.85 |
| | | | | | (1) | (1) | (2) |
| 14 | 17.60, 88.0 | — | 2.40, 12.0 | 1.53 | 1.57 | 1.47 | 1.58 |
| | | | | | (3) | (−4) | (3) |

### Example 15-20: Properties of Medium Viscosity Neat and Mixed Epoxy Resin Compositions as a Clear Cast and Preparation of Carbon-Carbon Composites Thereof

### Carbon Yields and Viscosities of Mixed Bisphenol F-Type Epoxy Resin Composition Clear Casts

A resin composition was prepared with a mixture of bisphenol F epoxy resin and phenol-formaldehyde novolac epoxy resin, a tertiary amine as the curing agent and an alkylating ester of para-toluene sulfonate as the latent catalyst as described in Table XIV for Examples 15-20; and according to the procedure described above in Process One under Composition Example 1.

The viscosity of a sample (1 g) was obtained on an AR2000EX instrument with a 60 mm 1° steel cone plate, with a 25 μm gap at 25° C. for 1 min. A 5 g portion of each of Examples 15-20 was cured and post cured in an Al pan (0.05 m diameter) as described in Tables II and IV. A portion of each of the cured examples (11 mg) was carbonized in a thermogravimetric analysis instrument (TA Q5000) at a temperature of from about 30° C. to about 1,000° C. at 10° C./min.

The carbon yield of Examples 15-20 is at least about 50% (52%-62%) for a useful precursor curable composition. The viscosity at 25° C. for Examples 15-20 is less than or equal to about 12.0 Pa-s, which is sufficient for processability and handleability of a useful precursor curable composition.

TABLE XIV
Viscosity and Carbon Yield of Thermally Cured Medium Viscosity Bisphenol
F-Type Epoxy Resin Compositions

| | D.E.R. 354 | D.E.N. 438 | | MPTS | Viscosity | Carbon Yield |
|---|---|---|---|---|---|---|
| Example | (g, wt %) | (g, wt %) | | (g, wt %) | (Pa · s, 25° C.) | (%) |
| | | | BDMA | | | |
| | | | (g, wt %) | | | |
| 15 | 9.29, 93.0 | — | 0.10, 1.0 | 0.60, 6.0 | 3.11 | 59 |
| 16 | 6.33, 63.2 | 2.59, 25.8 | 0.10, 1.0 | 1.00, 10.0 | 8.66 | 62 |
| 17 | 6.49, 64.6 | 2.65, 26.4 | 0.10, 1.0 | 0.80, 8.0 | 10.73 | 60 |
| 18 | 6.61, 66.0 | 2.70, 27.0 | 0.10, 1.0 | 0.60, 6.0 | 11.65 | 57 |
| 19 | 11.67, 77.8 | 2.57, 17.1 | 0.15, 1.0 | 0.60, 4.0 | 9.64 | 52 |
| | | | DMP-30 (g, | | | |
| | | | wt. %) | | | |
| 20 | 11.43, 76.1 | 2.51, 16.8 | 0.16, 1.1 | 0.90, 6.0 | 8.68 | 56 |

### Preparation of Carbon-Carbon Composite by Impregnating Carbon Fibers with Medium Viscosity Precursor

A carbon-carbon composite product was prepared by impregnating woven carbon fibers with the precursor curable compositions mentioned above, and using several methods (as described in WIPO WO 2013/188051 A1, incorporated herein by reference) such as: (1) resin transfer molding; (2) vacuum assisted resin transfer molding; (3) pressure assisted resin transfer molding; (4) dipping; (5) infiltrating; and (6) coating such as pouring, spraying, and rolling. The impregnated fiber matrix was then cured to form a cured precursor composite material. The cured precursor composite material was then carbonized to produce a carbon-carbon composite product.

### Example 21-26: Preparation of a Carbon Precursor and Carbon-Carbon Composite from a High Viscosity, Tacky Prepreg

### Carbon Yields and Viscosities of Bisphenol F Novolac Resin Composition Clear Casts

The prepreg resin composition was prepared with an phenol-formaldehyde epoxy novolac resin having different molecular weights, a tertiary amine as the curing agent and an alkylating ester of para-toluene sulfonate as the latent catalyst as described in the Tables XV, XVI, and XVII for Examples 21, 22, and 23-25, respectively; and according to the procedure in Part A Process One under Composition Example 2.

The viscosity of a sample (1 g) was obtained on an AR2000EX instrument with a 60 mm 1° steel cone plate with a 25 μm gap at 25° C. and 50° C. for 1 min. A 5 g portion of each of Examples 21-25 was cured and post cured in an Al pan as described in Tables II and IV. A portion (11 mg) of each of the cured examples was carbonized in a thermogravimetric analysis instrument (TA Q5000) at a temperature of from about 30° C. to about 1,000° C. at 10° C./min.

With and without solvent, the carbon yields of the compositions of Examples 21-25 are at least above about 50% (57%-58%). Without solvent, the 50° C. viscosity of precursor curable compositions of Examples 21 and 22 described in Tables XV and XVI, respectively, are about 26 Pa-s and 227 Pa-s, respectively.

Optionally, an organic solvent was added to the resin composition containing the D.E.N 438 novolac resin described in Table XVII to reduce the viscosity of the composition according to the procedure in Part B Process One under Composition Example 2. As observed with Examples 23-25, as low as 5 wt % of an organic solvent is sufficient to achieve an advantageous viscosity of less than about 80.0 Pa-s at 25° C. and less than about 4.0 Pa-s at 50° C. Addition of about 20 wt % solvent to the composition of Example 22 should advantageously lower the viscosity to less than about 80.0 Pa-s at 25° C. and less than about 4.0 Pa-s at 50° C.

TABLE XV
Viscosity and Carbon Yield of Thermally Cured
D.E.N. 438 Epoxy Novolac Resin Compositions

| | | | | Viscos- | |
|---|---|---|---|---|---|
| | D.E.N. | | | ity | Carbon |
| Exam- | 438 | BDMA | MPTS | (Pa · s, | Yield |
| ple | (g, wt. %) | (g, wt. %) | (g, wt. %) | 50° C.) | (%) |
| 21 | 9.30, 93.0 | 0.10, 1.0 | 0.60, 6.0 | 25.61 | 58 |

TABLE XVI
Viscosity and Carbon Yield of Thermally Cured
D.E.N. 439 Epoxy Novolac Resin Compositions

| | | | | Viscos- | |
|---|---|---|---|---|---|
| | D.E.N. | | | ity | Carbon |
| Exam- | 439 | BDMA | MPTS | (Pa · s, | Yield |
| ple | (g, wt. %) | (g, wt. %) | (g, wt. %) | 50° C.) | (%) |
| 22 | 9.30, 93.0 | 0.10, 1.0 | 0.60, 6.0 | 227.40 | 57 |

TABLE XVII
Viscosity and Carbon Yield of Thermally Cured D.E.N. 438 Epoxy Novolac
Resin Compositions in Organic Solvent

| | D.E.N. | | | | | | Carbon |
|---|---|---|---|---|---|---|---|
| | 438 | BDMA | MPTS | MEK | Viscosity | Viscosity | Yield |
| Example | (g, wt %) | (g, wt %) | (g, wt %) | (g, wt %) | (Pa · s, 25° C.) | (Pa · s, 50° C.) | (%) |
| 23 | 13.2, 88.2 | 0.14, | 0.86, 5.7 | 0.77, | 78.1 | 3.11 | 58 |
| | | 0.96 | | 5.10 | | | |
| 24 | 12.6, 83.6 | 0.14, | 0.81, 5.4 | 1.52, | 7.34 | 0.72 | 57 |
| | | 0.91 | | 10.1 | | | |
| 25 | 11.2, 74.3 | 0.12, 0.8 | 6.00, 4.8 | 3.03, | 0.46 | 0.13 | 57 |
| | | | | 20.1 | | | |

### Preparation of Carbon-Carbon Composite from a Prepreg

About 8-9 g of Example 26 precursor curable composition with solvent was poured over individual interwoven carbon fiber sheets (14 sheets; 17.8 cm×17.78 cm) such that 58 wt % of the resin composition without solvent was loaded onto 14 sheets of fiber total (as described in Table XVIII). The individual sheets were hung in convection oven for 2 hr at 70° C. to evaporate solvent. The tacky impregnated carbon fiber sheets were layered according to the following arrangement: 0°/45°/90°/45°/90°/45°/90°/90°/45°/90°/45°/90°/45°/90°. The 14-ply (17.8 cm×17.8 cm) prepreg was cured under pressure in a compression molder according to the schedule described in Table III.

TABLE XVIII
D.E.N. 438 Epoxy Novolac Resin Composition
for Prepreg Preparation

| | D.E.N. | | | |
|---|---|---|---|---|
| Exam- | 438 | BDMA | MPTS | MEK |
| ple | (g, wt %) | (g, wt %) | (g, wt %) | (g, wt %) |
| 26 | 148.81, 74.2 | 1.61, 0.80 | 9.59, 4.8 | 40.62, 20.3 |

The “green” carbon composite is subjected to carbonization to produce the carbon-carbon composite. Re-impregnation, curing, and carbonization can be done to densify the composite.

1. A precursor curable composition comprising
(a) at least one first epoxy resin;
(b) at least one latent catalyst;
(c) optionally, at least one curing agent;
(d) optionally, at least one organic solvent; and
(e) optionally, at least one second epoxy resin;
wherein the thermal stability of the precursor curable composition when aged at 50° C. for 16 days as measured by an increased 25° C. viscosity is from 0 percent to about 20 percent; and wherein, when the precursor curable composition is cured, the carbon yield of the cured precursor curable composition as measured by thermogravimetric analysis is at least about 50 percent, based on the total weight of the cured composition without the optional organic solvent.

2. The precursor curable composition of claim 1, wherein the at least one first epoxy resin is a bisphenol F-type epoxy resin.

3. The precursor curable composition of claim 1, wherein the at least one first epoxy resin is a naphthalene diglycidyl ether.

4. The precursor curable composition of claim 1, wherein the at least one first epoxy resin is a bisphenol F epoxy resin, a phenol-formaldehyde epoxy novolac resin; or mixtures thereof.

5. The precursor curable composition of claim 1, wherein the concentration of the at least one first epoxy resin is from about 50 weight percent to about 99 weight percent of the total composition weight.

6. The precursor curable composition of claim 1, wherein the latent catalyst is an alkylating ester of para-toluene sulfonate, methane sulfonate, or mixtures thereof.

7. The precursor curable composition of claim 1, wherein the latent catalyst is selected from the group consisting of methyl p-toluene sulfonate, ethyl p-toluenesulfonate, methyl methane sulfonate; and mixtures thereof.

8. The precursor curable composition of claim 1, wherein the concentration of the at least one latent catalyst is from about 1 weight percent to about 15 weight percent of the total composition weight.

9. The precursor curable composition of claim 1, including further at least one curing agent; wherein the at least one curing agent is a tertiary amine such as dimethylbenzyl amine, tris(dimethylaminomethyl)phenol, or 1,4-diazabicyclo-[2.2.2]octane; a Lewis acid complex such as boron trichlorise-N,N-dimethyloctylamine adduct; an imidazole such as 4-methyl-2-phenylimidazole and 1-azine-2-methylimidazole; and mixtures thereof.

10. The precursor curable composition of claim 1, wherein the concentration of curing agent is from about 0.5 weight percent to about 3 weight percent of the total composition weight.

11. The precursor curable composition of claim 1, further comprising at least one organic solvent; wherein the at least one organic solvent comprises methyl ethyl ketone, methyl n-amyl ketone, methyl isobutyl ketone, xylene, acetone or mixtures thereof.

12. The precursor curable composition of claim 1, wherein the concentration of organic solvent is from about 5 weight percent to about 40 weight percent of the total composition weight.

13. The precursor curable composition of claim 1, including further at least one second epoxy resin; wherein the at least one second epoxy resin is diglycidyl ether of 9,9-bis[4-hydroxy-phenyl]fluorene, bisphenol A, or resorcinol, o-cresyl glycidyl ether, or mixtures thereof.

14. A process for preparing a precursor curable composition, the process comprising admixing:
(a) at least one first epoxy resin;
(b) at least one latent catalyst;
(c) optionally, at least one curing agent;
(d) optionally, at least one organic solvent; and
(e) optionally, at least one second epoxy resin;
wherein the thermal stability of the precursor curable composition when aged at 50° C. for 16 days as measured by an increased 25° C. viscosity is from 0 percent to about 20 percent; and wherein, when the precursor curable composition is cured, the carbon yield of the cured precursor curable composition as measured by thermogravimetric analysis is at least about 50 percent, based on the total weight of the cured composition without the optional organic solvent.

15. A cured precursor composite material comprising a reaction product prepared by curing the precursor curable composition of claim 1.

16. A process for producing a cured precursor composite material comprising the steps of:
(i) providing a precursor curable composition comprising:
(a) at least one first epoxy resin;
(b) at least one latent catalyst;
(c) optionally, at least one curing agent;
(d) optionally, at least one organic solvent; and
(e) optionally, at least one second epoxy resin;
wherein the thermal stability of the precursor curable composition when aged at 50° C. for 16 days as measured by an increased 25° C. viscosity is from 0 percent to about 20 percent; and wherein, when the precursor curable composition is cured, the carbon yield of the cured precursor curable composition as measured by thermogravimetric analysis is at least about 50 percent, based on the total weight of the cured composition without the optional organic solvent; and
(ii) curing the precursor curable composition of step (i) at a temperature of from about −10° C. to about 300° C. sufficient to form a cured precursor composite material.

17. The process of claim 16, including further the step of impregnating a carbon fiber material with the precursor curable composition of step (i) before curing the precursor curable composition in step (ii).

18. A carbon-carbon composite product comprising a reaction product prepared by carbonizing the cured precursor composite material of claim 15.

19. A process for producing a carbon-carbon composite product comprising the steps of:
(I) providing a precursor curable composition comprising
(a) at least one first epoxy resin;
(b) at least one latent catalyst;
(c) optionally, at least one curing agent;
(d) optionally, at least one organic solvent; and
(e) optionally, at least one second epoxy resin;
wherein the thermal stability of the precursor curable composition when aged at 50° C. for 16 days as measured by an increased 25° C. viscosity from 0 percent to about 20 percent; and wherein, when the precursor curable composition is cured, the carbon yield of the cured precursor curable composition as measured by thermogravimetric analysis ranges from at least about 50 percent, based on the total weight of the cured composition without the optional organic solvent;
(II) impregnating a carbon fiber material with the precursor curable composition of step (I);
(III) curing the precursor curable composition impregnated carbon fiber material of step (II) to form a cured precursor composite material; and
(IV) carbonizing the cured precursor composite material of step (III) to form a carbon-carbon composite product;
wherein the carbon yield of the cured precursor composite material is at least 50 percent based on the total weight of the cured precursor curable composition used in step (II), excluding the amount of carbon fiber material used in step (II).

20. A process according to claim 19, wherein the at least one first epoxy resin is a naphthalene diglycidyl ether, the latent catalyst is an alkylating ester of para-toluene sulfonate, methane sulfonate, or mixtures thereof, further at least one curing agent; wherein the at least one curing agent is a tertiary amine such as dimethylbenzyl amine, tris(dimethylaminomethyl)phenol, or 1,4-diazabicyclo-[2.2.2]octane; a Lewis acid complex such as boron trichlorise-N,N-dimethyloctylamine adduct; an imidazole such as 4-methyl-2-phenylimidazole and 1-azine-2-methylimidazole, and mixtures thereof; at least one second epoxy resin; wherein the optional at least one second epoxy resin is diglycidyl ether of 9,9-bis[4-hydroxy-phenyl]fluorene, bisphenol A, or resorcinol, o-cresyl glycidyl ether, or mixtures thereof.
